(19) United States
(12) Patent Application Publication
(10) Pub. No.: US 2001/0027478 A1
(43) Pub. Date: Oct. 4, 2001

(54) Messaging system

(76) Inventors: Alan James Meier, Sidney (AU); Paul Ernest Meier, Auckland City (NZ)

Correspondence Address: YOUNG LAW FIRM, A PROFESSIONAL CORPORATION, 4370 ALPINE ROAD SUITE 106, PORTOLA VALLEY, CA, 94028

(21) Appl. No.: 09/754,073

(22) Filed: Jan. 3, 2001

(30) Foreign Application Priority Data
Jan. 5, 2000 (NZ) 502191
Apr. 12, 2000 (NZ) 502191
Jan. 5, 2000 (NZ) 502190
Apr. 12, 2000 (NZ) 502190

(51) Int. Cl. H04M 11/00; G06F 15/16; G06F 7/00; G06F 17/00

(52) U.S. Cl. 709/206; 709/245; 379/93.24; 707/104.1

(57) ABSTRACT

The system allows for the allocation of email addresses to almost every possible person within a country, and allows for easy lookup and/or addressing of messages whether by email, telephone, mail or fax to those subscribers. It makes use of a combination of the subscriber's telephone number and an alphabetical component chosen from their name, for individuals, or an alphabetical description of a department within a business, together with a database server that stores information about each subscriber, and their preferred mode of delivery. The system requires users to create or modify their primary account by a telephone interface, as the system allows for delivery of email messages to subscribers by telephone, mail or fax, to those subscribers who do not have access to a computer and thus access to software to read their emails.

### TECHNICAL FIELD OF THIS INVENTION

This invention relates to a messaging system, and has particular application to the transmission of messages by email. However it is not limited only to email, but envisages also the combination of email with other means of delivering messages either by hard copy, or via electronic means including the possibility of text messages, voice messages, or multi-media messages.

### BACKGROUND

The single best communication medium to date has been the telephone. It is still superior to email primarily because of two things, the first and most important is that it has a directory of all available numbers throughout the world, the second is that the numbers are relatively short making it easy verbally or otherwise to transmit the number to others. Text based messaging such as emails are often the most cost effective and convenient mechanism of communication. Emails however lack a true directory service and are also not universally available, the addressing schemes are in many cases long and character based so communicating the address initially is also a problem.

With the recent plethora of Internet services, particularly email servers, and the fact that many email addresses are country independent, it is difficult to locate the correct email address for your intended recipient, and if you have the misfortune to misplace that persons email address, or if you try to find that email address by searching the Internet, you are likely to not find the correct address, or alternatively find a large number of hits for the persons name and find it difficult to chose the correct email address, or indeed even locate the person.

This situation is compounded by the fact that with a number of different Internet providers (ISPs) people frequently change their ISP and hence their email address, and this makes it difficult to maintain contact with friends or business acquaintances, unless the recipient makes use of a forwarding service. Many people do not do this.

In addition to this, only a small percentage of people in each country have Internet addresses, and thus it is necessary to rely on faxes, voice messages by telephone, pager messages, or the physical delivering of mail through a postal or courier service.

There is a need for an improved messaging system, particularly one which allows for reliable collection of emails by the intended recipient.

### OBJECT

It is an object of this invention to provide an improved messaging system, or one that will at least provide the public with a useful choice.

### STATEMENT OF INVENTION

In one aspect the invention provides apparatus for delivering emails including: a database server containing a database made up of a plurality of records, each record in the database defining at least an account holder and an email address, wherein the email address contains at least (in whole or in part) the account holder's telephone number and (a) in the case of an individual, the account holders name, or (b) in the case of a business, the name of a department, and wherein each record follows a predetermined structure to facilitate use of that email address by another person.

Preferably each record contains instructions concerning the forwarding of an email received at that defined email address, to another email address designated by the account holder.

Preferably the database contains a plurality of records, preferably more than one per telephone number from a telephone directory, wherein each email address is made up of the account holder's chosen telephone number and (in whole or in part) the account holder's given name.

In another aspect the invention provides software for delivering emails to a subscriber, wherein the software contains or controls a database made up of a plurality of records corresponding to the entries in a telephone directory, each record defining an account holder and an email address, the email address containing at least (in whole or in part) the account holder's telephone number and (in whole or in part) the account holder's name, wherein each record follows a predetermined structure to facilitate use of that email address by another person.

Preferably each record contains instructions concerning the forwarding of an email received that defined email address, to another email address designated by the account holder.

Preferably the database contains a plurality of records, preferably more than one per telephone number from the corresponding telephone directory, wherein each email address is made up of the account holder's chosen telephone number and (in whole or in part) the account holder's given name.

In another aspect the invention provides a method for delivering messages by email to a recipient by allocating to each person within a defined group, an email address prefix (for use with an ISP suffix) the email address prefix being made up of a unique alphanumeric identification code, each of which codes incorporates a predetermined combination of a telephone number, and an alphabetic component, allowing users of the system to address an email to a recipient by entering the unique alphanumeric identification code with the appropriate ISP suffix, transmitting the desired email message to the recipient's ISP, the recipient's ISP then redirecting the email message to the recipient in a manner determined by the recipient (when registered with the ISP).

If the recipient's ISP determines that the recipient has not yet registered with the ISP (even though the sender knows the recipient's pre-allocated email address), the ISP can communicate with the recipient by telephone, or mail or some other medium to encourage the recipient to register in order to receive the email message waiting for the recipient.

Preferably the group is made up of all (or substantially all) of the persons listed in a telephone directory.

Preferably the group is made up of all (or substantially all) of the persons listed in all of the telephone directories in this country or a region or state in this country.

Alternatively or additionally the group is made up of all (or substantially all) of the companies or businesses listed in a telephone directory.

In another aspect the invention provides a database for use in routing messages to account holders, the database containing a plurality of records corresponding to one or more telephone directories, each record in the database defining at least an account holder and an email address, the email address containing at least (in whole or in part) the account holder's telephone number and (in whole or in part) the account holder's name, wherein each record a predetermined structure to facilitate use of that email address by another person.

Preferably each record contains instructions concerning the forwarding of an email received at that defined email address, to another email address designated by the account holder.

Preferably the database contains a plurality of records, preferably more than one per telephone number from the corresponding telephone directory, wherein each email address is made up of the account holder's chosen telephone number and (in whole or in part) the account holder's given name.

Preferably the database contains records corresponding to all or substantially all of the people listed in the telephone directories in this country or region or state in this country.

In another aspect, the invention provides a messaging system which uses a “media independent address” the details of which are stored on a database, the database comprising a plurality of records, each record being distinguished by its media independent address, and containing information on the account holder.

This database preferably includes the account holder's wishes as to the preferred means of delivery of the messages, and any filter that the account holder wishes to be placed on incoming messages.

Preferably the media independent address is an alphanumeric code based on the account owners telephone number, preferably country code, area code, full telephone number, and some part of the account owner's family name or given name or both, the details of which are set out in our New Zealand patent specification No. 502190 entitled “Identification System” the contents of which are incorporated herein and by way of reference.

In another aspect, the invention provides a messaging system capable of directing messages by email to a recipient by allocating to a person within a group (e.g. potential subscribers) an email address prefix (for use with an ISP suffix) a unique alphanumeric identification code, each of which codes incorporates a predetermined combination of: a unique number and an alphanumeric (or more preferably an alphabetic) component.

Preferably the unique number is one which can be looked up in a published list such as a directory of telephone numbers or company or business name registration numbers or occupation registration numbers.

In its most preferred form the invention provides a system for combing telephone numbers (including country code and area code information) with an alphanumeric (or more preferably an alphabetic) component representing individuals or departments at a particular location represented by the telephone number.

In a further aspect the invention provides a messaging system including a message storage or redirection centre which makes use of an identification system for individuals which is relatively easy for an individual to remember or use, which involves allocation to each individual in a group a unique alphanumeric identification code, each of which codes incorporates a predetermined combination of:

an individuals country code;

an individuals locality (e.g. area) code;

an alphanumeric representation of at least part of an individual's name; and

at least part of an individual's listed number (e.g. a listed telephone number).

These and other aspects of this invention, which should be considered in all its novel aspects, will become apparent from the final description, which is given by way of example only.

### DRAWINGS

FIG. 1 shows a schematic of a preferred computer interface,

FIG. 2 shows a schematic of a preferred fax interface,

FIG. 3 shows a schematic of the third mail interface,

FIG. 4 shows a schematic of a preferred phone interface.

### EXAMPLES

### Example 1

As an example, consider the population of a country such as New Zealand. It is about 4 million people. Each of these individuals can be provided with an individual alphanumeric code based on the following predetermined rule:

International telephone country code, telephone area code, local residential telephone number, then a character based string (preferably chosen from alphabetical characters) or a numeric or an alphanumeric string representing that individual.

A fictional example may be a household of 2 adults and 4 children, in Wellington New Zealand (country code 64, area code 4) each with the family name SMITH, with given names as follows:

John, Mary, Michael, Joseph, Jean, Jane.

Telephone number say 569-3578

Their individual codes would be:

64-4-569-3578-JOHS for John Smith

64-4-569-3578-MARS for Mary Smith

64-4-569-3578-MICS for Michael Smith

64-4-569-3578-JOSS for Joseph Smith

64-4-569-3578-JEAS for Jean Smith

64-4-569-3578-JANS for Jean Smith

The dashes have been inserted to show the constituent parts of the complete codes, in practice they could be omitted.

By using the identification system of Example 1, it is possible to allocate a meaningful code to known individuals within a group, for example the group could consist of all adults in New Zealand, or in fact all adults and children in New Zealand. This code can then be used as an email address or as a “media independent address”, when used in conjunction with a database server. There are various permutations and combinations that could be used with such an identification system.

One advantage of such an email addressing system is that almost everyone in a country can be provided with an easily remembered (and easy to find) email address. Other advantages are discussed below.

### Example 2

Instead of using a numeric identifier for the country code, the International Standard two letter country code could be used, so that the code for John Smith would be:

NZ-4-569-3578-JOHS for John Smith

Email System

By allocating codes to individuals, it is possible to provide each individual with a “virtual” email address. For example if the system operator is a ISP, and allocates accounts to the various individuals giving each individual an email address based on their individual codes. In the case of John Smith the email would be 64-4-569-3578-johs@“ISPNAME”.com

The applicant proposes to use an ISP name such as “fleximail.com” so that the address for John Smith would be 64-4-569-3578-johs@fleximail.com.

(Note that dashes are not necessary—they are shown here to aid in dissecting the component parts of the address).

Users could have the choice of accessing that email address directly, or using it as a virtual email address, together with an appropriate forwarding system so that emails can be forwarded to the email account they prefer to use, or for those customers who do not use email any messages received at that email address could be forwarded to the customers in whatever way they chose.

The system lends itself to providing free email addresses to customers, in a similar fashion to “hot mail”, or one of the other international free email services.

### Example 3

Instead of using a complete telephone number with country and area code as the prefix of the individual code, the order could be varied so that family name and country code came first.

John Smith could thus have a code based on any one of the following permutations:

SMITH-NZ-JOHN-4-569-3578—this uses the full telephone number.

SMITH-NZ-JOHN-4-3578—using only last 4 digits of telephone number

Unified Messaging System

By using the identification codes as “media independent address”, it is possible to use the database server as a clearing house for all different types. For example, knowing the address code for John Smith 64-4-569-3578-JOHS@FLEXIMAIL.com it is then possible to address mail by simply putting that on the label and nothing else, and posting it using one of the mail carriers. The address code includes country and area code information, as well as the name of the ISP. That ISPFLEXMAIL.com can provide a physical address or pick up point for such mail, for example it might have interconnection agreement with various mail and courier services, or it might simply have a physical delivery address, or it might recommend to customers to use its own nominated mail service for such deliveries.

There are many different possibilities for delivering mail to the ISP, and many different ways that the ISP can then automate the onward transmission or storage of that mail to the intended recipient.

For example, John Smith may prefer that hard copy mail be opened and faxed to a particular fax number which he has designated, or that it be scanned and transmitted as an attachment to an email to his designated address, or he may prefer that he is contacted in another way perhaps by pager message, an email message, or a voice mail message to say that mail is waiting for his collection, or he may prefer that the message is read out to him over the telephone.

The choice of the delivery is up to the recipient, and the recipient may have different rules in his account for holding or onward transmission of mail, at different times, or he may paste different rules on the mail depending on the type of mail to be delivered to him. recipient may wish to place a filter on certain mail so that “junk mail” or a specified category of mail is filtered out and not delivered.

That address code for John Smith can be used by others to send John Smith faxes, emails, voice mail, multi-media information, in fact any information of any type that needs to be transmitted either physically or electronically to John Smith.

This media independent address deals with a situation of a number of individuals at a particular household. It also allows the ISP to provide means for looking up the subscribers at a particular address. The inventor believes that such a look up function should be limited to individuals or companies who are already subscribed to the messaging system, so that information is not misused.

For example, if a subscriber wishes to send an email address to an individual at the Smith household, and he knows the phone number but not the particular email addresses, he could then either email or telephone the ISP, and the ISP could then provide information on the subscribers at that particular telephone number. The sequence could be as follows:

Enquiring subscriber dials the ISP phone number, this would typically be an 0800 number, possibly 0800FLEXIMAIL. An automated answering system would then ask the subscriber to enter their own telephone or account number. The system would then ask the subscriber which telephone number they wish to access and then the subscriber could then enter that telephone number as 64-9-569-3578 and then the system could read back to the enquiring subscriber the identity and codes of the people at that address. In its most simplified form the system could say if you wish to send a message to:

John Smith press 1, Mary Smith press 2, Michael Smith press 3 etc . . .

The enquiry subscriber having chosen to send a message in this case to Mary Smith would press 2 on their telephone keypad, and could then hear the precise email address if that is what they wanted to send, or if they wanted to send a voice message at this point they could dictate the voice message which would be transmitted to the ISP and then the ISP could determine how to deliver that voice message to Mary Smith.

For example, Mary Smith's account might say that voice messages are to be transcribed and forwarded on an email addresses, or forwarded as pager messages via her pager service or might request that she be notified of voice mail messages and simply dials in at her own convenience to listen to the voice mail messages. In extreme case the voice mail message could be converted into text, faxed to the nearest delivery point, and delivered as physical mail, either through the mail carrier or delivered immediately by hand, emulating the old style of telegram service. Again the delivery means can be chosen by the recipient, depending upon convenience, the location of the recipient, and the costs of the different delivery routes.

It is envisaged that initially many customers will prefer to have text messages delivered by a mail courier or by fax rather than by email, although as the system takes off more and more people will use some sort of email deliver as the preferred means of collecting their messages.

### Example 4

This system can be used for businesses as well as residential addresses. In the case of businesses having a large number of departments and a large number of staff, the messaging system may well acquire an expansion to the media independent address perhaps by including the department, for example sales, accounts, manufacturing or some abbreviation of these terms, in association with the recipients name, or in some case just simply using the accounts as the final part of the address without there being any particular individual nominator.

The following is an example in the form of a commented list of what the user would actually do to send a message or read a message using the phone system to send/retrieval system.

Registering a New Account

Note that everyone would have an account initially but they are all unregistered until the user actually registers it.

1. User rings local registration presence number.

2. System identifies incoming number by CLI and looks up unregistered accounts against that number.

3. User is prompted as to which account they wish to register, there is also an option for New Account.

4. User is then prompted to confirm the First Name and their last name along with the spelling. If incorrect the user is asked to re-enter the incorrect part via touch-phone

5. After confirmation of name the system creates a standard alpha part of email address from the users name according to the standard rules. The user is then asked whether they wish to customise the standard alpha signature for the account. They press # to accept or * to modify.

6. After acceptance of the alpha name the system then prompts the user to enter a 4 or more digit pin number and press #.

7. The user is then asked to reconfirm the pin number.

8. The system congratulates the user for establishing their account and if there are any messages will ask the user whether they wish to read them.

Sending a Message

1. User calls local presence number for message service.

2. User enters his telephone number (user can also enter # if the phone they are calling from is the actual phone number, saves dialling numbers).

3. User then enters their 4 digit pin code. This code identifies the account of the user at that number (see security issues for what happens on incorrect pin codes).

4. User presses the number 2 button to send a message using phone format or the number 3 button for regular alphanumeric format.

5. (assuming user pressed button 2). The user is now prompted to enter the phone number of the destination. If the user does not enter a country or area code then the country and area code of the local presence number is used (if no such phone combination exists then the user is informed and given the option to re-enter the number).

6. After successfully entering a phone number the system then looks up the people that have accounts at that number and reads their names to the user along with the corresponding number to press if they wish to choose that address. The user presses the number that matches the address they are seeking.

7. The user is then asked whether they wish to add a further address to the list of recipients in which case they enter a further number and repeat the process or press the # key to exit addressing the email.

8. The user is now prompted to leave the verbal message and press the # button to end the message

9. The user is now asked whether they wish to send a further message. They can now hang up the phone if they wish to terminate the session.

Retrieving Faxes/Letters/Emails/Voice Messages Via Phone

1. User calls local presence number for message service

2. User enters his telephone number (user can also enter # if the phone they are calling from is the actual phone number, saves dialling numbers).

3. User then enters their 4 digit pin code. This code identifies the account of the user at that number (see security issues for what happens on incorrect pin codes).

4. User presses the number 1 button retrieve any messages.

5. System will read each message to the user via Text to Speech technology if it was an email/fax/letter or simply play if it is a voice mail.

6. At the end of each message the user is asked whether they wish to Delete the message, Onsend to Computer email account for record keeping, Leave message in queue and go to next message.

7. User is informed when all messages have been read.

Electronic Email Addressing

The system would also accept standard electronic emails. Since our system actually knows the first and last name of the user it could also be more forgiving when it came to incorrectly addressed emails. If no matching account could be found the system would look at the first name of each account to see whether there was a match, if there is then it would be sent to that person. When this happens an email is also sent back to the sender informing them of what has happened.

Other phone facilities that would need to be provided by the system include:

1. Change pin number

2. Change alpha name

3. Transfer phone number

4. SPAM filtering maintenance

5. Malicious email filtering maintenance

6. On-Forwarding of mail to a new number.

7. Silent Number handling

### Example 5—Drawings

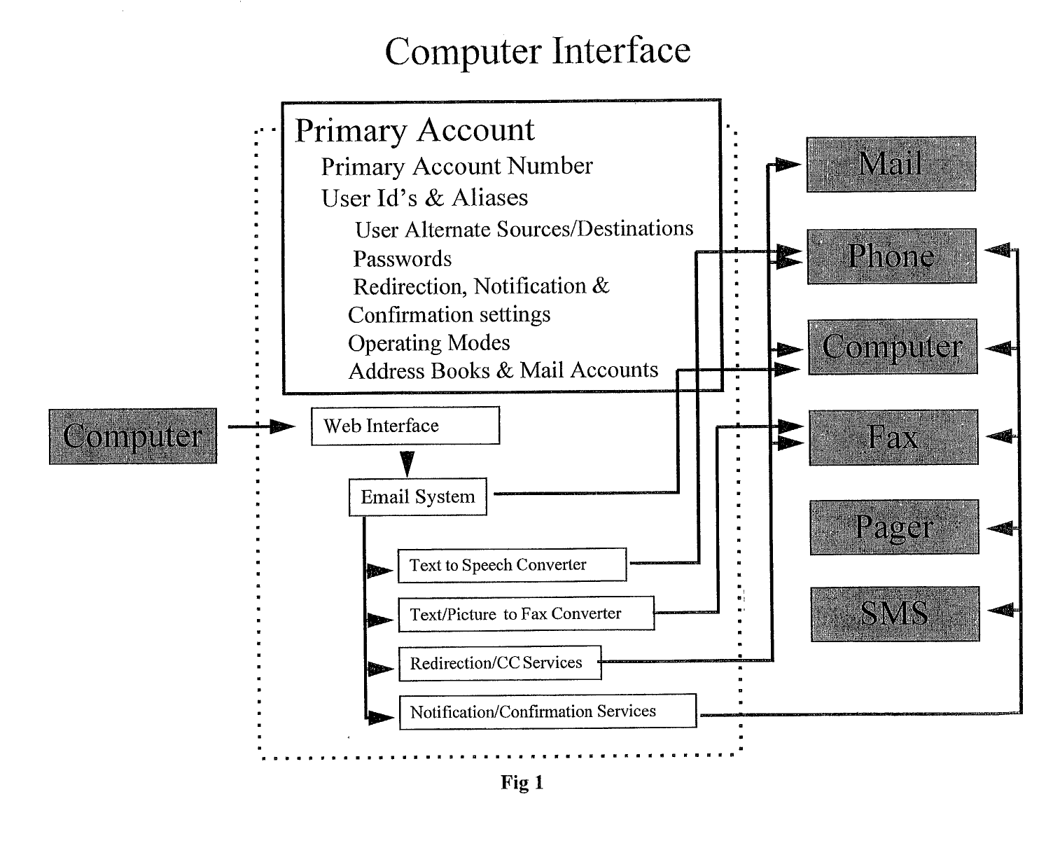

FIGS. 1-4 are schematics of the different interfaces to the system. FIG. 1 is a schematic of a preferred computer interface. In this example the customer could dial into the computer interface either by a direct dial line, or more preferably via the Internet. By dialling into the web interface the user can interact with the email system, and obtain a variety of different outputs as shown in FIG. 1.

We prefer that the primary account can be modified only via the telephone interface. Although it may be possible to provide other forms of modifying the primary account, we prefer for security reasons to use the telephone interface. The following items can be modified in our preferred system via the telephone interface:

Individual redirection settings

Individual notification settings

Individual confirmation settings

User password

Aliases to user id

Additional phone numbers can be added

Paging devices can be added

Fax devices can be added

The redirection/CC services would automatically select and use the most appropriate form to do the redirection. For example in the case of a fax it would create picture formats for an email then fax the resultant pictures with an appropriate header, in the case of mail it would print all relevant documents and put them in an envelope and post them.

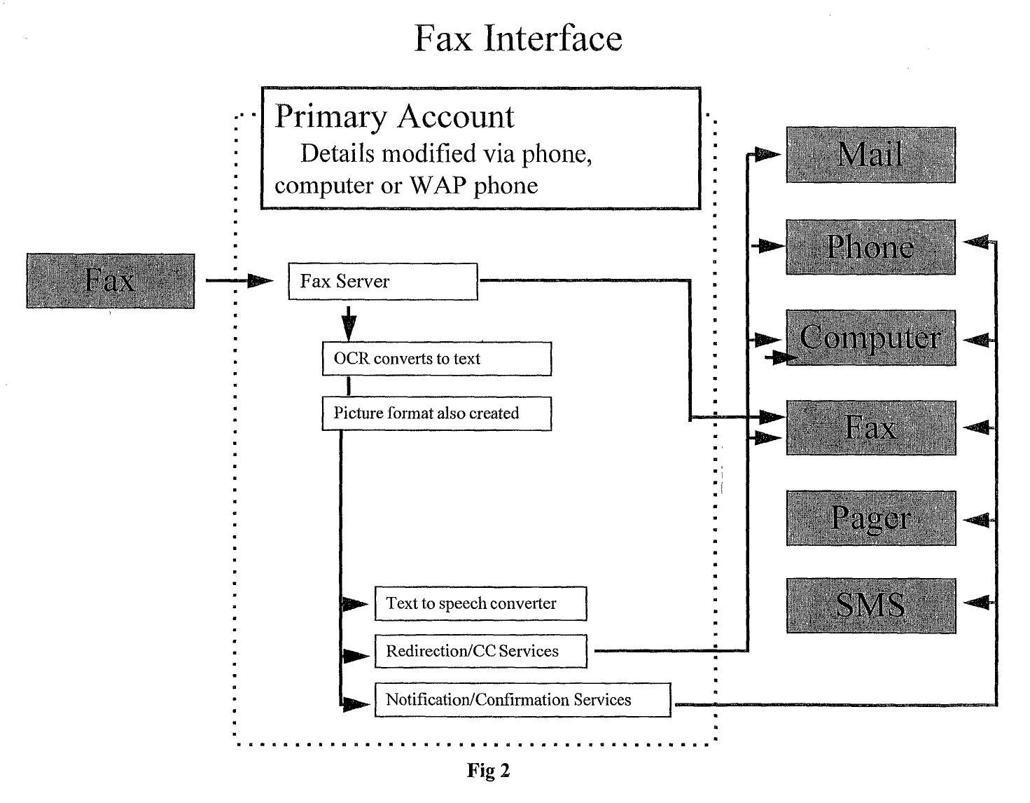

FIG. 2 shows a preferred fax interface.

In this case an incoming fax would be received by the fax server, and re-directed, in accordance with the controls set-up in the database server. In one path, the incoming fax may be sent out again as a fax to a fax forwarding address. In the other path, the incoming fax will be captured by the fax server, passed through an optical character recognition process to convert the fax information to text, and if a picture is present, capturing the picture also as a digital file, and then passing the text and/or the digital picture file to one of the three outputs shown at the bottom of FIG. 2, namely:

(a) Text to speech converter,

(b) Redirection/CC services, or

(c) Notification/confirmation services.

The output of which may then be sent to the customer or the customers forwarding address by a variety of means as shown in the right hand column of FIG. 2.

Once again it is our preferred set-up that the primary account can only be modified by the phone or computer/web interfaces.

The redirection/CC services would automatically select and use the most appropriate form to do the redirection, for example in the case of a fax it would be scanned as a picture then attached to an email, in the case of a phone interface it would use OCR technology to convert the document to text then leave it as a voicemail.

For confirmation of delivery it is assumed that a mail carrier (in New Zealand it is envisaged that National Mail will be the chosen carrier) will provide some sort of ability to confirm that a delivery has taken place electronically so it will automatically link in with the system.

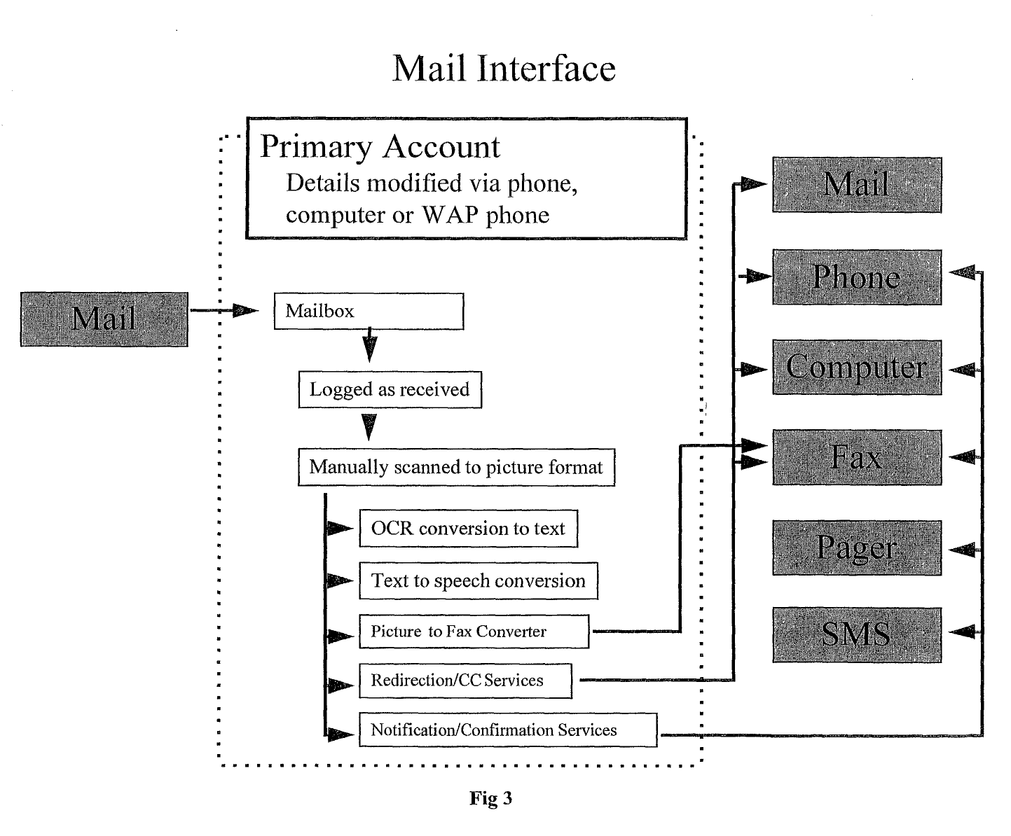

FIG. 3 shows a preferred mail interface.

This has many features in common with the fax interface, in that a hard copy is received in a mail box, it is logged as received, and then manually scanned to picture format, and the picture format is then dealt with in a fashion similar to an incoming fax.

The message can then be forwarded by means of a fax output, or any of the other possible outputs shown on the right hand side of FIG. 3.

As before, it is preferred that the primary account can only be modified by the phone and/or computer/web interfaces.

The redirection/CC services would automatically select and use the most appropriate form to do the redirection, for example in the case of a fax it would be scanned as a picture then attached to an email, in the case of a phone interface it would use OCR technology to convert the document to text then leave it as a voicemail.

For confirmation of delivery it is assumed that a mail carrier (in New Zealand it is envisaged that National Mail will be the chosen carrier) will provide some sort of ability to confirm that a delivery has taken place electronically so it will automatically link in with the system.

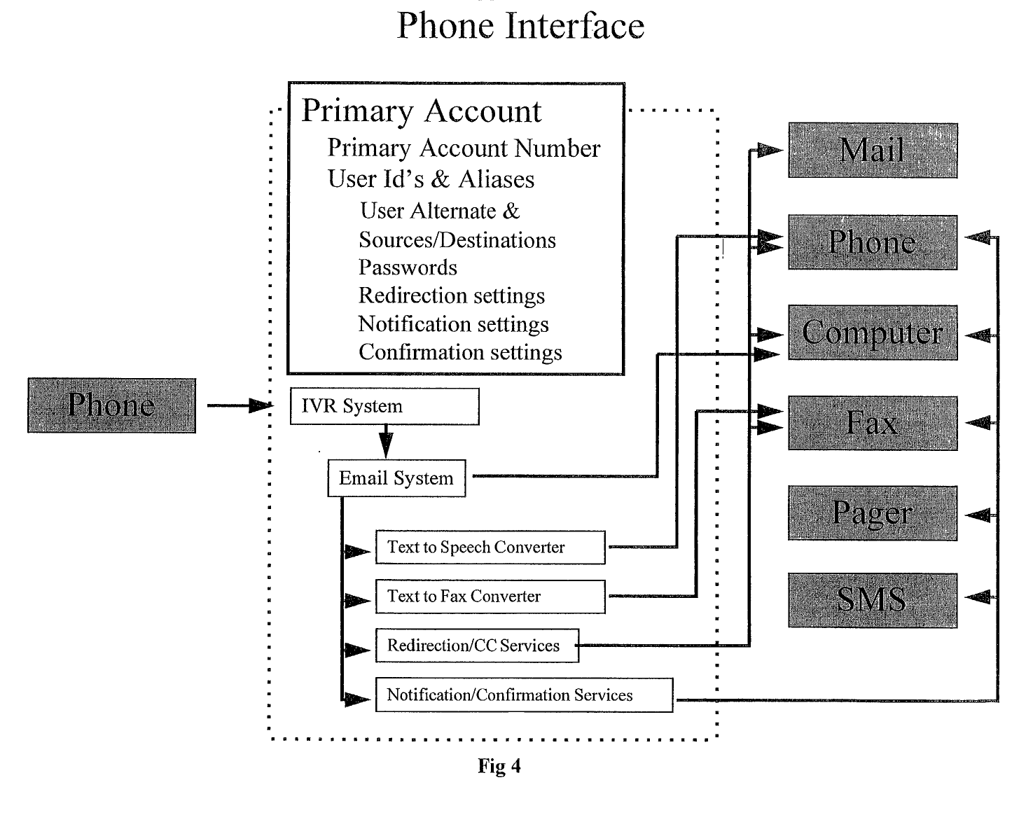

FIG. 4 shows a preferred telephone interface.

Because the system is based on the assumption that the telephone interface will be used to set-up and modify the primary account as will be discussed below, as the customer's telephone number forms an important part of the registration process and hence their email address.

It is preferred that the primary account can be created or modified via the phone interface. In the system, it is preferred that the following items can be modified by the phone:

Individual redirection settings

Individual notification settings

Individual confirmation settings

User password

Aliases to user id

Additional phone numbers can be added

Paging devices can be added

Fax devices can be added

The redirection/CC services would automatically select and use the most appropriate form to do the redirection, for example in the case of a fax it would use a speech to text conversion process or a human translator, create a picture of the text and fax that, in the case of a mail interface it would use a speech to text converter or a human translator to create a text document which would then be printed, addressed and delivered.

Note that IVR means Interactive Voice Response system. The existing interface currently does not have voice recognition incorporated in it but it is anticipated that this will be included in the near future, for example when looking up addresses in an address book technology already exists to say the persons name and it will look up similar sounding names in the address book and prompt the user with them.

### Example 6—Detailed Description

Overview

The aim of this detailed example is three fold:

1. To provide a universal directory mechanism as a basis for the messaging needs of the individual. Below are examples of its use:

a. Provide a simple method for users to send and receive emails via the use of a telephone.

b. Passing business and personal contact details between individuals. This can be done either verbally by phone or in a more automated electronic fashion via email or other electronic transaction mechanism. (Privacy issues would be addressed).

c. Automated filling in of details for Internet based systems such as: Name, Address or Telephone (credit card information may also be added later). We would give websites a way to obtain the customers details in a more direct fashion, customer enters phone number+alpha code then password, site obtains all other details securely and automatically)

2. To provide a universal email by phone service for people who do not have a computer. Customers would have an option of paying a monthly fee for service or being given access to the service for free in exchange for 10 second advertisements preceding emails that are received.

3. To provide the basis for a unified messaging system for both personal and business use that includes all common types of messaging: Letters (Physical Addresses), Email, Voicemail, Voice-Emails, Telephone and Fax. The service would include:

a. Sending/Receiving Emails via Telephone

b. Redirection

c. Forwarding

d. Carbon Copying

e. Notification of Receipt

f. Notification of Delivery

Notes on Limitations of System

In the current system all pagers are treated the same, on the assumption that all pagers used with this system will have an electronic interface so text can be transmitted via email. If needed, the system may have to differentiate between different types of pagers for the purposes of sending them a message. Additional error messages may need to be added if some pagers do not have an electronic interface.

It is important to note that at this stage we will only provide redirection of voice-emails not diversion of calls.

Redirection services from a fax will only be able to be provided if we issued the customer the fax number. Otherwise no redirection will be allowed to a fax.

For alternate email accounts it is important to understand that only other POP3 accounts will be able to be added to the system. A proprietary internal mail system will not be able to be used with the system. It is also to be noted that if they have their computer on at home all the time that is also reading the POP3 account, in most cases they will receive no messages as the other computer would have retrieved and deleted the messages. It requires the user to close their mail application on their home computer for it to work correctly.

Conventions

Important notes are in Italics

Menu Names are in Bold Italics

Voice prompts the user receives are in ‘quotes’

If there are specific responses that are generated against a particular prompt they will appear underneath and indented to the right of the prompt.

xx is the maximum length of a recorded message to be sent

When there are multiple options that all share the same sub-options on selection, only one of the items from the list will contain the sub-options, the others are left with no explanation.

No explanation will be provided, if what selecting a menu option does is very obvious, e.g. ‘Press star to return to the previous menu’. In most cases there is no explanation as to what happens when the user chooses the option.

General User Interface Notes

Although the help menus have been referred to extensively within this document, none of the text is provided, it is outside the scope of the document.

In many instance menus call other menus, when the menu called returns to the calling menu, the system will automatically re-prompt (read it to the user) the menu for the user.

When the system get to the end of prompting a menu it will pause for 2 seconds and if there is no user interaction will re-prompt (read it to the user) the menu for the user.

Because the following description provides a very detailed example of one form of the invention we have numbered each chapter heading as part of this example. For example the first chapter will be Example 6.1“Issue New Password (Operator Assisted)”. The following is a summary of the chapter headings forming part of Example 6:

Example 6.1—Issue New Password (Operator Assisted)

Example 6.2—Establish New Account (Operator Assisted)

Example 6.3—User Directory Assistance

Example 6.4—Customer Log-in Menu

Example 6.5—Enter Password Menu

Example 6.6—Manual Password Menu

Example 6.7—Enter Initial Password Menu

Example 6.8—Main Menu

Example 6.9—Further Mail Options

Example 6.10—Send Contact Details

Example 6.11—Read Unread Messages Menu

Example 6.12—End of Message Menu

Example 6.13—National Email Reply Menu

Example 6.14—Email Reply Menu

Example 6.15—Carbon Copy Menu

Example 6.16—Email Address Book Menu

Example 6.17—Forward Email Menu

Example 6.18—Send Voice-Email Menu

Example 6.19—Record Message Menu

Example 6.20—Maintain Password Menu

Example 6.21—Maintain User Password Menu

Example 6.22—Change Operating Mode Settings

Example 6.23—Modify Operating Mode Settings

Example 6.24—Set Confirmation Menu

Example 6.25—Set Notification Menu

Example 6.26—Set Carbon Copy Settings Menu

Example 6.27—Set Redirection Menu

Example 6.28—Internal Destination Menu

Example 6.29—Maintain Barred Addresses

Example 6.31—Review/Delete Barred List

Example 6.32—Maintain Valid Addresses

Example 6.3—Add Valid Address Menu

Example 6.34—Review/Delete Valid Addresses List

Example 6.35—Maintain Source And Destination Devices Menu

Example 6.36—Add New Source/Destination Device

Example 6.37—Add Phone Number Menu

Example 6.38—Add Fax Number Menu

Example 6.39—Add Pager Number Menu

Example 6.40—Delete Device Menu

Example 6.41—Maintain User Accounts

Example 6.42—Super-User Delete Existing User Menu

Example 6.43—Super-User Change Existing Super-User Menu

Example 6.44—Super-User Modify Existing Users Password Menu

Example 6.45—Super-User Add New User Menu

Example 6.46—Add New Alias Menu

Example 6.47—Modify User Id & Aliases Menu

Example 6.48—Modify Surname Menu

Example 6.49—Modify First Name Menu

Example 6.50—Modify User Id Menu

Example 6.51—Modify Alias Name Menu

Example 6.52—Delete Alias Menu

Example 6.53—Maintain User Id's and Aliases Menu

Example 6.54—Maintain Physical Address

Example 6.55—Maintain Alternate Email Accounts

Example 6.56—Account Maintenance Menu

Example 6.57—Account Settings Menu

Example 6.58—Forward All Mail Menu

Example 6.59—Remove Forward All Mail Menu

Example 6.60—Relinquish Account Number

Example 6.61—Delete Change of Address Forwarding Id's Menu

Example 6.62—Web Interface

### Example 6.1

Issue New Password (Operator Assisted)

This allows the customer that has forgotten their password to have customer service operator modify it for them:

1) A special account establishment number is provided that would give the user an IVR prompt to collect their phone number if no CLI (Calling Line Identification) is available.

2) Customer calls the special number.

3) If the customers CLI information is not available the IVR asks the customer to:

a) ‘Please enter the phone area code and phone number you are calling from’.

i) If the user fails to enter a valid phone number the user receives the following prompt:

(1) ‘Not a valid phone number’

(2) ‘Try again’

(3) The user is taken back to step (a)

4) The system automatically queues the call for an operator.

5) An automated system drops the call in on the operator and a screen pops up for the operator with the customers phone number in it.

6) The operator talks with the customer, explains that they must be at an extension of the account phone number. If the customer is at an extension attached to the account number the operator asks them to hang up and then calls the customer back at the number on their screen.

a) The customer establishes what the new password should be and changes it for the customer.

### Example 6.2

Establish New Account (Operator Assisted)

There is an area that cannot be addressed completely electronically as we do not have access to the Telecommunication company's change of address information, so we can determine when a number is disconnected from one user and another user takes over the number. Below is an operator-assisted method for handling this process:

1) A special account establishment number is provided that would give the user an IVR prompt to collect their phone number if no CLI (Calling Line Identification) is available.

2) Customer calls the special number.

3) If the customers CLI information is not available the IVR asks the customer to:

a) ‘Please enter the phone area code and phone number you are calling from’.

i) If the user fails to enter a valid phone number the user receives the following prompt:

(1) ‘Not a valid phone number’

(2) ‘Try again’

(3) The user is taken back to step (a)

4) The system automatically queues the call for an operator.

5) An automated system drops the call in on the operator and a screen pops up for the operator with the customer's phone number in it.

6) The operator talks with the customer, explains that they must be at an extension of the account phone number. If the customer is at an extension attached to the account number the operator asks them to hang up and then calls the customer back at the number on their screen.

a) If the customer is not at the number, the call is terminated.

b) If the customer is at the number the customer service operator will create a super user account from information the customer supplies over the phone, (First name, Surname, User Id and Password), the account used is the phone number that they called the customer on.

### Example 6.3

User Directory Assistance

This is a phone number that users can call which will give them the User Ids of any other phone number to make regular emailing easier.

1) ‘Welcome to National Email, please enter the accounts phone area code and phone number that you want the user information of’.

a) If the number entered is not valid the user receives the following prompt:

i) ‘Not a valid account number, please try again’.

(1) This will automatically take the user back to Step 1

b) If a valid account phone number is entered the system looks up the users that belong to that account and prompts them in the following menu format:

i) ‘The alphanumeric Id for the users of this account are as follows:’

ii) ‘A L A M for Alan Meier’

iii) ‘L E O M for Leon Meier’

iv) ‘Press one to enter another account phone number’. v) ‘Press star to return to the main menu without sending your contact details’.

vi) ‘Press the hash key twice for help on how to use the information provided.

c) If the number is silent the user is given the following prompt:

i) ‘The number you have specified is silent and the accounts User Id's are not publicly available’.

ii) ‘Press one to enter another account phone number’.

(1) Takes the user back to Step 1.

iii) ‘Press star to return to the main menu without sending your contact details’.

iv) ‘Press the hash or pound key twice for help on this menu’.

### Example 6.4

Customer Login Menu

This menu is presented to the customer when they first dial in. They are immediately prompted with the following:

1) ‘Welcome to National Email, please enter your account phone area code and phone number’.

a) If the number entered is not valid the user receives the following prompt:

(1) ‘Not a valid account number, please try again’.

(a) This will automatically take the user back to Step 1.

b) If there is only one user attached to the account and the users account has been initialized the User Id will be automatically selected and the user is taken directly to the Enter Password Menu.

c) If there is more than one User Id in the Account or there is a single user that has not been initialized in the account the system will give the following prompt:

(1) ‘Please select your User Id’

(2) ‘Press one for Alan Meier’

(i) If the Users account has been suspended and the user is not the User Id the following prompt is given to the user:

a. ‘Your account has been suspended, because there were four successive attempts to enter your password unsuccessfully. Please ask your super user Leon Meier to change your password for you, so access can be permitted again, press star to hear this message again’.

(ii) If the Users account has been suspended and the user is the User Id the following prompt is given to the user:

a. ‘Your account has been suspended, because there were four successive attempts to enter your password unsuccessfully. Please call our customer service department on xxxx xxxx so a new password can be arranged’.

b. ‘Press one to be transferred to our customer service department now’.

c. ‘Press star to listen to this message again’.

d. ‘Press the hash or pound key twice for help on this menu’.

(iii) If the user selects a User Id and the Id is initialized they are taken to the Enter Password Menu.

(iv)If the user selects a User Id that has not been initialized and the CLI (Calling Line Identification) matches the Account Phone Number, they are taken to the Enter Initial Password Menu.

(v) If the user selects a User Id that has not been initialized and the CLI (Calling Line Identification) does not match the Account Phone Number, they are taken to the Manual Password Menu.

(2) ‘Two for Leon Meier’

(3) ‘Three for Paul Meier’

(4) ‘Press star to enter your account number again’.

(5) ‘Press the hash or pound key twice for help on this menu’.

Note that once the user identifies their number in the list of users they can simply add it to their phone number when logging in and they will be taken directly to the Enter Password Menu, skipping this menu altogether.

### Example 6.5

Enter Password Menu

This menu allows the user to enter their password and log onto the National Email system, the user is given the following prompt:

1) ‘Please enter your four digit password’.

a) If the user takes longer than 40 seconds to enter the password or the password entered is incorrect the following prompt is given to the user:

i) ‘Invalid password’

ii) ‘Press 1 to enter your password again’.

iii) ‘Press star to return to the Customer Login Menu’.

iv) ‘Press the hash or pound key twice for help on this menu’.

b) If the user enters four invalid passwords in a row, this could be over more than one log-in session, the account is automatically suspended and one of the following prompts is given to the user:

i) If the User is not the designated super user the following prompt is given:

(a) ‘Your account has been suspended, because there were four successive attempts to enter your password unsuccessfully. Please ask your super user Leon Meier to change your password for you, so access can permitted again’.

(b) ‘Press star to hear this message again’.

ii) If the user is the designated super user the following prompt is given:

(a) ‘Your account has been suspended, because there were four successive attempts to enter your password unsuccessfully. Please call our customer service department on xxxx xxxx so a new password can be issued’.

(b) ‘Press one to be transferred to our customer service department now’.

(c) ‘Press star to listen to this message again’.

c) If the user enters a password that matches the one stored against their User Id they are taken to the Main Menu.

### Example 6.6

Manual Password Menu

This menu is presented to users who are trying to initialize their passwords but their CLI does not match that of the accounts phone number:

1) If there is already a super user with an initialized password the user will be given the following prompt:

a) ‘In order to initialize your password you must be using a phone extension connected to the actual account phone number. Please ask your super user Leon Meier to initialize your password for you, if you are not in a position to call from the actual account phone number’.

b) ‘Press star to listen to this message again’.

c) ‘Press the hash or pound key twice for help on this menu’.

2) If there is no super-user with an initialized password the user is given the following prompt:

a) If there is no CLI (Calling Line Identification) available the following prompt is given to the user:

i) ‘In order to initialize your password you must be using a phone extension connected to the actual account phone number. The phone number also has to have Calling Line Identification enabled. If you are calling from your account phone number now, Calling Line Identification is not enabled and you will need to call our customer service department on xxxx xxxx to have a password created for you. If you are not calling from your account phone number then please try again from your account phone number’.

ii) ‘Press one to be transferred to our customer service department now’.

iii) ‘Press star to listen to this message again’.

iv) ‘Press the hash or pound key twice for help on this menu’.

b) If the users CLI (Calling Line Identification) is available but it is different to the account phone number, the user will be given the following prompt:

i) ‘In order to initialize your password you must be using a phone extension connected to the actual account phone number. Please try again using a phone extension of your account phone number’.

ii) ‘Press star to listen to this message again’.

iii) ‘Press the hash or pound key twice for help on this menu’.

### Example 6.7

Enter Initial Password Menu

This menu allows the user to create their initial password. The user is given the following prompt:

1) ‘Welcome, before you can use your National Email account you need to initialize your password. This is necessary to ensure the privacy of your account’.

2) ‘Passwords must be four digits in length. To create your password, enter its four digit number now’.

a) If the user does not enter a minimum of four digits or more than xx seconds has elapsed since the prompt the following prompt is given:

i) ‘Passwords must be four digits in length’.

ii) ‘Press one to try to initialize your password again’.

iii) ‘Press star to return to the Customer Login Menu’.

b) If the user enters four digits they are given the following prompt:

i) ‘Please confirm your password by entering it again now’.

(1) If the user enters four digits but they do not match the first four digits entered or more than 30 seconds has elapsed, the user will be given the following prompt:

(i) ‘The password just entered does not match the original password entered’.

(ii) ‘Press one to try to initialize your password again’.

(iii)‘Press star to return to the Customer Login Menu’.

(iv) ‘Press the hash or pound key twice for help on this menu’.

(2) If the four digits entered match the first four digits entered and the user is not the first to be initialized in the account the user receives the following prompt and is then taken to the Main Menu:

(i) ‘Your account has been successfully initialized’.

(ii) ‘Press one for information on how to use your National Email account’.

1. Takes the user to an introduction menu that explains how to use and maintain their account with National Email.

(iii)‘Press two to go to the Main Menu and start using your account’.

1. Gives the following prompt to the user and then takes them to the Main Menu.

a. ‘Now going to the Main Menu’.

(iv) ‘Press three to hear this message again’.

(v) ‘Press the hash or pound key twice for help on this menu’.

(3) If the four digits entered match the first four digits entered and the user is the first to be initialized in the account the user receives the following prompt and is then taken to the Main Menu:

(i) ‘Your account has been successfully initialized’.

(ii) ‘You are the designated super user for this account’.

(iii) Press one for information on how to use your National Email account’.

1. Takes the user to an introduction menu that explains how to use and maintain their account with National Email and also what their responsibilities as a super user are.

(iv) ‘Press two to go to the Main Menu and start using your account’.

1. Gives the following prompt to the user and then takes them to the Main Menu.

a. ‘Now going to the Main Menu’.

(v) ‘Press three to hear this message again’.

(vi) ‘Press the hash or pound key twice for help on this menu’.

### Example 6.8

Main Menu

This is the menu the user gets after logging in and entering their password.

1) If there is one message in the users email box the following prompt will be given:

a) ‘There is one unread message in your email box’.

2) If there is more than one message in the users email box the following prompt will be given:

a) ‘There are two unread emails in your email box’.

3) If there are no messages in the users email box the following prompt is given:

a) ‘There are no unread messages in your email box’.

4) ‘Press one to read your unread messages’.

a) Choosing this item takes the user to the Read Unread Messages Menu. Note that this prompt does not appear if there are no unread messages in the users email box.

5) ‘Two to read your saved messages’.

a) Choosing this item takes the user to the Read Saved Messages Menu. Note that this prompt does not appear if there are no saved messages in the users email box.

6) ‘Three to send an Voice-Email’.

a) Choosing this item takes the user to the Send Voice-Email Message Menu.

7) ‘Four for Further Mail Options’.

a) Choosing this item takes the user to the Further Mail Options Menu.

8) ‘Five to Maintain your Account’.

a) Choosing this item takes the user to the Account Maintenance Menu.

9) ‘Press star to end this session’.

10) ‘Press the # or pound key twice for help on this menu’.

### Example 6.9

Further Mail Options

This menu provides the user with further options for their mail handling:

1) ‘Mail Options Menu’.

2) ‘One to send your contact details’.

a) Choosing this item takes the user to the Send Contact Details Menu.

3) ‘Two to change your Redirection Settings’.

a) Choosing this item takes the user to the Change Redirection Menu.

4) ‘Three to change your confirmation settings’.

a) Choosing this item takes the user to the Change Confirmation Menu.

5) ‘Four to change your Carbon Copy Settings’.

a) Choosing this item takes the user to the Change Carbon Copy's Menu.

6) ‘Five to Set your Operating Mode’

a) Choosing this item takes the user to the Change Operating Mode Menu.

7) ‘Press star to return to the Main Menu’.

8) ‘Press the # or pound key twice for help on this menu’.

### Example 6.10

Send Contact Details

This menu allows the user to send their contact details to any valid destination. The user is prompted with the following:

1) ‘Press one to send all your contact details including your physical address’.

a) If the user chooses either one or two they are given the following prompt:

i) ‘Please enter the phone area code and phone number you wish to send your contact details to or press the star key to use an address from your address book or press hash to use an Internal destination’.

(1) If the user presses the star key they are taken to the Address Book Menu.

(2) If the user presses the hash key they are taken to the Internal Destination Menu.

(3) If a valid National Email Account was entered and the User Id of this user is found in the accounts Barred Addresses list the following prompt is given to the user:

(a) ‘Your address has been barred from sending any further messages to this users account’

(b) ‘Press star to return to the main menu’.

(c) ‘Press the hash or pound key twice for help on this menu’.

(4) If a valid account phone number is entered the system looks up the users that belong to that account and provides the following prompt format:

(a) ‘Press one to enter a different phone number’.

(i) Returns the user to the step 1.

(b) ‘Two for Alan Meier’

(c) ‘Three for Leon Meier’

(i) Selecting this option prompts the user with the following and returns them the Main Menu.

(ii) ‘Your details have been sent to Leon Meier, now returning to the Main Menu’.

(d) ‘Press star to return to the main menu without sending your contact details’.

(e) ‘Press the hash or pound key twice for help on this menu’.

(5) If the user fails to enter a valid phone number the user receives the following prompt:

(a) ‘Not a valid phone number’.

(b) ‘Press one to enter the account phone number again’.

(i) Takes the user back to Step 1.

(c) ‘Press star to return to the main menu without sending your contact details’.

(d) ‘Press the hash or pound key twice for help on this menu’.

(6) If the number is silent the user is given the following prompt:

(a) ‘The number you have specified is silent and your address is not listed in the account as one from which mail may be received’.

(b) ‘Press one to enter another account phone number’.

(i) Takes the user back to Step 1.

(c) ‘Press star to return to the main menu without sending your contact details’.

(d) ‘Press the hash or pound key twice for help on this menu’.

b) ‘Press star to return to the Main Menu’.

c) ‘Press the hash or pound key twice for help on this menu’.

2) ‘Two to send your phone and email details only’.

3) ‘Press star to return to the Main Menu’.

4) ‘Press the hash or pound key twice for help on this menu ’.

### Example 6.11

Read Unread Messages Menu

When the user enters this menu the system will automatically start to read any unread messages form the users mailbox if there are any.

1) If there are unread messages available the user will be given the following prompt:

a) ‘While a message is being read press star at any time to delete the message being read and skip to reading the next message. Alternatively use the hash key to skip to the End of Message Menu. You may also enter any of the options from the end of message menu while the message is being read . T his message will not be read after it has been played to you three times’.

Note that this prompt will only be given a maximum of once per user login session.

b) The system will then read the oldest unread message to the user, prompting the user with the End of Read Message Menu after the message has been read.

2) If there are no unread or saved messages the user will be given the following prompt:

a) ‘There are no messages in your mail box, now returning to the Main Menu’.

3) If there are no unread messages but there are saved messages the user will be given the following prompt:

a) ‘There are no unread messages in your mail box, now returning to the Main Menu’.

### Example 6.12

End of Message Menu

This menu appears at the end of each message or whenever the user presses the hash key while a message is being read. The functions of the menu are also available to the user while the message is actually being read to them, making is faster for power users of the system.

1) If the actual message was completely read, i.e. the user did not skip using the hash key, the user is given the following prompt:

a) ‘End of Message’.

2) If the user used the hash key to skip to this menu the following prompt is given to the user:

a) ‘End of Message Menu’.

3) ‘Press one to delete this message and play the next’.

a) Deletes the current message and takes the user to the Read Unread Messages Menu.

4) ‘Two to save this message and play the next’.

a) Saves this message and plays takes the user to the Read Unread Messages Menu.

5) ‘Three to play the message again’.

a) Plays the message again for the user.

6) ‘Four to reply to this message’.

a) Choosing this option takes the user to the National Email Reply Menu if the original message originated from a National Email account or the Email Reply Menu if it came from an external email source.

7) ‘Five to forward this message to another user’.

i) Choosing this option takes the user to the Forward Message Menu.

8) ‘Six to add this Email address to your Address book’.

a) The system would automatically add the email address to the address book. If the email belongs to a National Email account the first name and surname are added to the address book as well otherwise the fields are left blank. The user is then given the following prompt:

i) If the mail address was a National Email Account the user receives the following prompt:

(1) ‘Address of Paul Smith has been successfully added’.

ii) If the mail address was not a National Email Account the user receives the following prompt:

(1) ‘Address jmeier@isolve.com.au has been successfully added’.

9) ‘Eight to bar any future messages from this address’.

a) The user is given the following prompt after the system has added the message to the users barred addresses list:

(1) ‘Address has been successfully added to the barred address list’.

ii) If the mail address was a National Email Account the user receives the following prompt:

(1) ‘Address of Paul Smith has now been added to your Barred Addresses List’.

iii) If the mail address was not a National Email Account the user receives the following prompt:

(1) ‘Address jmeier@isolve.com.au has now been added to your Barred Addresses List’.

10) ‘Press the star key to return to the Main Menu.

11) ‘Press the hash or pound key twice for help on this menu’.

### Example 6.13

National Email Reply Menu

This menu appears when a user wishes to reply to an Email message with another Email message. The user will receive the following menu:

1) ‘Please record your message after the tone then press the star key to end the message and return to this menu’.

a) If more than xx seconds has elapsed the user is given the following prompt:

i) ‘The maximum message length of xx minutes has been reached, message truncated’.

b) If the user has pressed star or the message has been truncated the following prompt is given:

i) ‘Press one to send the message’.

(a) If the address is a National Email Account the system will check whether the sender appears in the addressee's Barred Addresses list and if it does, gives the user the following prompt:

1. ‘Your address has been barred from sending any further messages to this users account’.

2. ‘Press star to return to the main menu’.

3. ‘Press the hash or pound key twice for help on this menu’.

(b) If the address is not barred the user is given the following prompt and then returned to the End of Message Menu:

1. ‘Message sent, returning to the End of Read Message menu’.

ii) ‘Two to play the message recorded’.

(1) Replays the message the user recorded and returns to this menu.

iii) ‘Three to record the message again’.

(1) Takes the user back to Step 1.

iv) ‘Four to forward this message to another recipient’.

(1) Choosing this option takes the user to the Forward Email Menu.

v) ‘Five to Carbon Copy this message to another recipient’.

(1) Choosing this option takes the user to the Carbon Copy Menu.

vi) ‘Press the star key to return to the End of Message Menu without replying’.

vii) ‘Press the hash or pound key twice for help on this menu’.

### Example 6.14

Email Reply Menu

This menu appears when a user wishes to reply to a standard text Email message with another either voice or text email message. The user will receive the following menu:

1) ‘Press the hash key to use a standard response or record your message after the tone then press the star key to end the message and return to this menu’.

a) If the user presses the hash key the following menu prompt is given:

i) ‘Press one for Yes’.

ii) ‘Press two for No’.

iii) ‘Press three for Go ahead’.

iv) ‘Press four for Message received, will reply in due course’.

(a) Choosing this option will send a text reply to the senders address with the message in the prompt, the user is then given the following prompt and is returned to the End of Message Menu.

(1) ‘Reply sent, now returning to the End of Message Menu’.

v) ‘Press star to return to the previous menu’.

vi) ‘Press the hash or pound key twice for help on this menu’.

b) If more than xx seconds after the tone has elapsed the user is given the following prompt:

i) ‘The maximum message length of xx minutes has been reached, message truncated’.

c) If the user has pressed star or the message has been truncated the following prompt is given:

i) ‘Press one to send the message’.

(a) If the address is a National Email Account the system will check whether the sender appears in the addressee's Barred Addresses list and if it does, gives the user the following prompt:

1. ‘Your address has been barred from sending any further messages to this users account’.

2. ‘Press star to return to the main menu’.

3. ‘Press the hash or pound key twice for help on this menu’.

(b) The user is not barred from sending they are given the following prompt, the system sends the voice-email to the address and is then returned to the End of Message Menu:

1. ‘Message sent, returning to the End of Read Message menu’.

ii) ‘Press Two to play the message recorded’.

(1) Replays the message the user recorded and then goes back to Step C.

iii) ‘Press Three to record the message again’.

(1) Takes the user back to Step 1.

iv) ‘Press Four to Carbon Copy this message to another recipient’.

(1) Choosing this option takes the user to the Carbon Copy Menu.

v) ‘Press the star key to return to the previous menu without replying’.

vi) ‘Press the hash or pound key twice for help on this menu’.

### Example 6.15

Carbon Copy Menu

This allows the user to Carbon Copy an email to any other valid destination. The user receives the following menu:

1) ‘Please enter the phone area code and phone number you wish to carbon copy the message to or press star to use an address from your address book or press hash to use an Internal Destination’.

a) If the user presses the star key they are taken to the Address Book Menu.

b) If the user presses the hash key they are taken to the Internal destination Menu.

c) If a valid National Email Account was entered and the User Id of this user is found in the accounts Barred Addresses list the following prompt is given to the user:

i) ‘Your address has been barred from sending any further messages to this users account’.

ii) ‘Press zero to enter a different phone number’.

(1) Choosing this takes the user back to Step 1.

iii) ‘Press star to exit the Carbon Copy Menu’.

iv) ‘Press the hash or pound key twice for help on this menu’.

d) If a valid account phone number is entered and the user is not barred and the number is not silent the system looks up the users that belong to that account and provides the following prompt format:

i) ‘Press one for Alan Meier’.

ii) ‘Press two for Leon Meier’.

(a) Selecting this option gives the user the following prompt and returns the user to the pervious menu.

(1) ‘This address has been added to the emails carbon copy list’.

iii) ‘Press zero to enter a different phone number’.

(1) Choosing this takes the user back to Step 1.

iv) ‘Press star to exit the Carbon Copy Menu without adding an address’.

v) ‘Press the hash or pound key twice for help on this menu’.

e) If the user fails to enter a valid phone number the user receives the following prompt:

i) ‘Not a valid account phone number’.

ii) ‘Press zero to enter a different phone number’.

(1) Choosing this takes the user back to Step 1.

iii) ‘Press star to exit the Carbon Copy Menu without adding an address’.

iv) ‘Press the hash or pound key twice for help on this menu’.

f) If the number is silent the user is given the following prompt:

i) ‘The mail account you have specified is silent and your address is not listed in the account as one from which mail may be received’.

ii) ‘Press zero to enter a different phone number’.

(1) Choosing this takes the user back to Step 1.

iii) ‘Press star to exit the Carbon Copy Menu without adding an address’.

iv) ‘Press the hash or pound key twice for help on this menu’.

2) If the addressing menu returns and an address was successfully added the following menu is given to the user:

a) ‘Press one to add a further Carbon Copy address’.

i) Choosing this takes the user back to step 1.

b) ‘Two to remove all Carbon Copy addresses’.

i) Choosing this option removes all Carbon Copy addresses from the menu and gives the user the following prompt and goes to Step 3:

(1) ‘All carbon copy addresses have now been removed’.

c) ‘Press star to return to the previous menu’.

d) ‘Press the hash or pound key twice for help on this menu’.

3) If the addressing menu returns and no address was added the following menu is given to the user:

a) ‘Press one to Carbon Copy this message to another address’.

i) Takes the user back to Step 1.

b) ‘Press star to return to the previous menu’. c) ‘Press the hash or pound key twice for help on this menu’.

### Example 6.16

Email Address Book Menu

This menu is used to add addresses to an email from the users address book. The user will receive the following menu:

1) If the user has no entries in their address book the following prompt is given to the user and they are taken back to the calling menu:

a) ‘There are no entries in your address book, now returning to the previous menu’.

2) If there are address book entries the following rules will be applied.

a) If there are less than 8 addresses the system will present them as in the following prompt:

i) ‘Press one for John Smith’.

ii) ‘Press two for Bill Banks’.

iii) ‘Press three for Jill Jameson’.

(1) On choosing an address the system will give the following prompt and return to the calling menu:

(a) ‘Address Jill Jameson selected, now returning to the previous menu’.

iv) ‘Press four for James Lang’.

v) ‘Press five for Alan Meier’.

vi) ‘Press star to return to the previous menu with choosing an address’.

vii) ‘Press the hash or pound key twice for help on this menu’.

b) If there are more than 8 addresses in the address book the system will give the user the following prompt:

i) ‘Please enter the first letter of the persons surname via your keypad for a list of addresses under that letter’.

(1) A menu containing the names in the address book whose surnames start with the two letters will be voiced.

(a) ‘Press one for John Mills’.

(b) ‘Two for Peter Mills’.

(i) On choosing an address the system will give the following prompt and return to the calling menu:

1. ‘Address Peter Mills selected, now returning to the previous menu’

(c) ‘Press star to return to the previous menu with choosing an address’.

(d) ‘Press the hash or pound key twice for help on this menu’.

### P1 Example 6.17

Forward Email Menu

This allows the user to forward an email to any other valid destination. The user receives the following menu:

1) ‘Please enter the phone area code and phone number you wish to forward the message to or press star to use an address from your address book or press hash to use an Internal Destination’.

a) If the user presses the star key they are taken to the Address Book Menu.

b) If the user presses the hash key they are taken to the Internal destination Menu.

c) If a valid National Email Account was entered and the User Id of this user is found in the accounts Barred Addresses list the following prompt is given to the user:

i) ‘Your address has been barred from sending any further messages to this users account’.

ii) ‘Press zero to enter a different phone number’.

(1) Choosing this option takes the user back to Step 1.

iii) ‘Press star to exit the Forward Email Menu’.

iv) ‘Press the hash or pound key twice for help on this menu’.

d) If the user fails to enter a valid phone number the user receives the following prompt:

i) ‘Not a valid account phone number’.

ii) ‘Press zero to enter a different phone number’.

(1) Choosing this option takes the user back to Step 1.

iii) ‘Press star to return to exit the Forward Email Menu’.

iv) ‘Press the hash or pound key twice for help on this menu’.

e) If the number is silent the user is given the following prompt:

i) ‘The mail account you have specified is silent and your address is not listed in the account as one from which mail may be received’.

ii) ‘Press zero to enter a different phone number’.

(1) Choosing this option takes the user back to Step 1.

iii) ‘Press star to exit the Forward Email Menu’.

iv) ‘Press the hash or pound key twice for help on this menu’.

f) If a valid account phone number is entered and the user is not barred from addressing and the number is not silent the system looks up the users that belong to that account and provides the following prompt format:

(1) ‘Press one for Alan Meier’.

(2) ‘Two for Leon Meier’.

(a) Selecting this option gives the user the following prompt and returns the user to the previous menu:

(b) ‘The message will be sent to Leon Meier’.

(3) ‘Press zero to enter a different phone number’.

(a) Choosing this option takes the user back to Step 1.

(4) ‘Press star to exit the Forward Email Menu’.

(5) ‘Press the hash or pound key twice for help on this menu’.

2) If the addressing menu returns and an address was successfully added the following menu is given to the user:

a) ‘Press one to forward this message to the recipient’.

i) Choosing this option gives the user the following prompt and then returns to the previous menu.

(1) ‘Message forwarded, now returning to the End of Read message Menu’.

b) ‘Two to change the forwarding address’.

i) Choosing this option removes the original forwarding address from the menu and gives the user the following prompt and goes to Step 1:

(1) ‘Forwarding address removed’.

c) ‘Three to Carbon Copy this message to another recipient’.

i) Choosing this option takes the user to the Carbon Copy Menu.

(1) On return from this menu the user is taken back to Step 2.

d) ‘Press star to return to the previous menu’.

e) ‘Press the hash or pound key twice for help on this menu’.

3) If the addressing menu returns and no address was added the following menu is given to the user:

a) ‘Press one to set the address to forward this message to’.

i) Choosing this option takes the user back to Step 1.

b) ‘Press star to exit this menu without forwarding the message’.

c) ‘Press the hash or pound key twice for help on this menu’.

### Example 6.18

Send Voice-Email Menu

This allows the user to send a voice-email message to another email user. The user receives the following menu:

1) ‘Please enter the phone area code and phone number you wish to send the message to or press star to use an address from your address book or press hash to use an Internal Destination’.

a) If the user presses the star key they are taken to the Address Book Menu.

b) If the user presses the hash key they are taken to the Internal destination Menu.

c) If a valid National Email Account was entered and the User Id of this user is found in the accounts Barred Addresses list the following prompt is given to the user:

i) ‘Your address has been barred from sending any further messages to this users account’.

ii) ‘Press zero to enter a different phone number’.

(1) Choosing this option takes the user back to Step 1.

iii) ‘Press star to exit the Send Voice-Email Menu’.

iv) ‘Press the hash or pound key twice for help on this menu’.

d) If the user fails to enter a valid phone number the user receives the following prompt:

i) ‘Not a valid account phone number’.

ii) ‘Press zero to enter a different phone number’.

(1) Choosing this option takes the user back to Step 1.

ii) ‘Press star to return to exit the Send Voice-Email Menu’.

iv) ‘Press the hash or pound key twice for help on this menu’.

e) If the number is silent the user is given the following prompt:

i) ‘The mail account you have specified is silent and your address is not listed in the account as one from which mail may be received’.

ii) ‘Press zero to enter a different phone number’.

(1) Choosing this option takes the user back to Step 1.

iii) ‘Press star to exit the Send Voice-Email Menu’.

iv) ‘Press the hash or pound key twice for help on this menu’.

f) If a valid account phone number is entered the system looks up the users that belong to that account and provides the following prompt format:

i) ‘Press one for Alan Meier’.

ii) ‘Press two for Leon Meier’.

(a) Selecting this option gives the user the following prompt and then goes to Step 2:

(i) ‘The message will be sent to Leon Meier’.

iii) ‘Press zero to enter a different phone number’.

(1) Choosing this option takes the user back to step 1.

iv) ‘Press star to exit the Send Voice-Email Menu’.

v) ‘Press the hash or pound key twice for help on this menu’.

2) ‘Press one to record and send the message’.

a) Choosing this option takes the user to the Record Message Menu.

3) ‘Two to change the address the message is being sent to’.

a) Choosing this option removes the original receivers address from the menu and gives the user the following prompt and goes to Step 1:

i) ‘Address removed, now returning to address entry.

4) ‘Three to carbon copy the message to another recipient’.

a) Choosing this option takes the user to the Carbon Copy Menu.

5) ‘Press star to return to the Main Menu’.

6) ‘Press the hash or pound key twice for help on this menu’.

### Example 6.19

Record Message Menu

This menu allows the user to record a message that will be sent to another recipient:

1) ‘Record your voice message after the tone, press the star key to end the message’.

a) If the user presses star or more than xx seconds has elapsed the user is given the following menu prompt:

i) ‘Press one to send the message’.

(a) After choosing this item the user receives the following prompt and returns them to the Main Menu.

(i) ‘Message Sent, now returning to the Main Menu’.

ii) ‘Two to play the message you have recorded’

(1) Choosing this option will cause the recorded message to be played again and on completion the user is taken back to Step (i).

iii) ‘Three to record the message again’.

(1) Choosing this option takes the user back to Step 1.

iv) ‘Press star to exit this menu without sending a message’.

(1) This returns the user to the Main Menu.

v) ‘Press the hash or pound key twice for help on this menu’.

### Example 6.20

Maintain Password Menu

This menu allows the user to change their password. The user is given the following menu:

1) ‘Change Password Menu’.

2) ‘Passwords must be 4 digits in length. Please enter your new four digit password now’.

a) If the user does not enter a minimum of four digits or more than xx seconds has elapsed since the prompt the following menu is given:

(1) ‘Passwords must be four digits in length’

(2) ‘Press one to begin changing your password again’.

(a) Choosing this option takes the user back to Step 2.

(3) ‘Press star to return to the Maintain Account Menu’.

(4) ‘Press the hash or pound key twice for help on this menu’.

b) If the user enters four digits they are given the following prompt:

(1) ‘Please confirm your new password by entering it again now’.

(i) If the user enters four digits but it does not match the first four digits entered or more than 30 seconds has elapsed, the user will be given the following menu:

a. ‘The password entered does not match the original password entered’.

b. ‘Press one to try changing your password again’.

c. ‘Press star to return to the Maintain Account Menu’.

d. ‘Press the hash or pound key twice for help on this menu’.

(ii) If the four digits entered match the first four digits entered the user receives the following prompt and then taken to the Main Menu:

a. ‘Your password has been successfully changed, now returning you to the Maintain Account Menu’.

### Example 6.21

Maintain User Password Menu

This menu allows the super user to change another users password. The super user is given the following menu:

1) ‘Passwords must be 4 digits in length. Please enter a new four digit password for the User now’.

a) If the super user does not enter a minimum of four digits or more than xx seconds has elapsed since the prompt the following menu is given:

(1) ‘Passwords must be four digits in length’.

(2) ‘Press one to begin changing the users password again’.

(3) ‘Press star to return to the Maintain Account Menu’.

(4) ‘Press the hash or pound key twice for help on this menu’.

b) If the user enters four digits they are given the following prompt:

(1) ‘Please confirm the users new password by entering it again now’.

(i) If the user enters four digits but they do not match the first four digits entered or more than 30 seconds has elapsed, the user will be given the following prompt:

a. ‘The password entered does not match the original password entered’.

b. ‘Press one to try changing the users password again’.

c. ‘Press star to return to the Maintain Account Menu’.

d. ‘Press the hash or pound key twice for help on this menu.

(ii) If the four digits entered match the first four digits entered the user receives the following prompt and then taken to the Main Menu:

a. ‘The users password has been successfully changed, now returning you to the Maintain Account Menu’.

### Example 6.22

Change Operating Mode Settings

This menu allows the user to change the current redirection setting mode, they are given the following menu:

1) If the user has used the web interface to set-up their operating mode settings the user will receive the following prompt:

a) ‘Your settings are currently in “Away from Work” mode’.

b) ‘Press one to change your setting to “At Work”’.

i) Choosing this option will set Confirmation, Redirection and Notification settings to those specified in the ‘At Work’ Operating Mode Settings. The following prompt is given to the user and they are returned to the Main Menu’.

(1) ‘Your settings have now been changed to those specified in the At Work Operating Mode, now returning to the Main Menu’.

c) ‘Two to change your setting to “Away from Work”’.

d) ‘Three to change your setting to “At Home”’.

e) ‘Four to change your setting to “Away from Home”’.

f) ‘Five to change your setting to “On Vacation”’.

g) ‘Press star to exit to the Main Menu’.

h) ‘Press the hash or pound key twice for help on this menu’.

Note that only the mode settings that the user has actually modified via the Internet Interface will actually appear in the menu for selection.

2) If the user has not set up their operating mode settings they will receive the following prompt:

a) ‘Due to the nature of Operating Mode Settings it is too time consuming to modify them via the telephone. The simplest way of modifying them is to use your Internet Account with us. Your account with us is free and was automatically created for you when you registered with the National Email service. To log onto your account go to our web site at www.xxx.co.nz, there you will be asked to enter your phone number and password to log into your account, all your account settings may then be modified more easily, including Group Settings and Address Books. If you do not own a computer yourself, ask a friend that has one or use one of the Internet Cafes that are available in most cities, you will now be returned to the main menu’.

b) ‘Press 1 to hear this message again’.

c) ‘Press star to exit to the Main Menu’.

d) ‘Press the hash or pound key twice for help on this menu’.

### Example 6.23

Modify Operating Mode Settings

This menu allows the user to change the current redirection setting mode, they are given the following menu:

1) ‘Due to the nature of Operating Mode Settings it is too time consuming to modify them via the telephone. The simplest way of modifying them is to use your Internet Account with us. Your account with us is free and was automatically created for you when you registered with the National Email service. To log onto your account go to our web site at www.xxx.co.nz, there you will be asked to enter your phone number and password to log into your account, all your account settings may then be modified more easily, including Group Settings and Address Books. If you do not own a computer yourself, ask a friend that has one or use one of the Internet Cafes that are available in most cities, you will now be returned to the main menu’.

2) ‘Press one to hear this message again’.

3) ‘Press star to exit to the Main Menu’.

4) ‘Press the hash or pound key twice for help on this menu’.

### Example 6.24

Set Confirmation Menu

This menu allows the user to set whether to receive confirmation of delivery of messages from a designated source. The user is presented with the following menu:

1) If there are currently active Confirmation of Delivery settings the following prompt will be given to the user:

a) ‘Press one for a list of currently active confirmation of delivery assignments or’

i) This prompts the user with a list of the currently active Confirmation of Delivery assignments:

(1) ‘Your Confirmation of Delivery Assignments are:’

(2) ‘Fax number 9999 0408 has confirmation turned on’

(3) ‘Press star to return to the Confirmation of Delivery menu’

(4) ‘Press the hash or pound key twice for help on this menu’

2) If the user has no active confirmation of deliver assignments the user will receive the following prompt:

a) ‘You have no Confirmation of Deliver Assignments at present’

3) ‘Choose the source that you wish to change the Confirmation of Delivery settings of’

4) ‘Press two for Email number 9979 8221’

5) ‘Press Three for Physical Address 7 Kara Crescent’

a) If the source selected currently has Confirmation turned on, the user will be prompted with the following:

i) ‘Press one to turn Confirmation of Delivery off for Physical Address 7 Kara Crescent’

(1) Choosing this option turns the confirmation setting of the device off and gives the user the following prompt, then returns the user to step 3:

(a) ‘Confirmation of Delivery for Physical Address 7 Kara Crescent has now been turned off, now returning to previous menu’

ii) ‘Press star to return to the previous menu’.

iii) ‘Press the hash or pound key twice for help on this menu’.

b) If the source selected does not have confirmation of delivery on then the user is given the following menu:

i) ‘Select the destination device to receive Confirmation of Delivery on’.

ii) ‘Press one for Email number 9979 8221’.

iii) ‘Two for Pager number 9876 5443’.

(1) Choosing this option causes the system to make confirmation of deliveries to the designated source device active and the user will receive a message to confirm that delivery has taken place for each item delivered:

(a) ‘Confirmation of Delivery for mail sent from Physical Address 7 Kara Crescent will be received on Pager 9876 5443, now returning to Main Menu’.

iv) ‘Press star to exit this menu without making any changes’.

v) ‘Press the hash or pound key twice for help on this menu’

Note that all devices except the selected source will appear in this list.

6) ‘Press four for Email Account ameier@isolve.com.au’.

7) ‘Press five for your Fax number 9999 0408’

8) ‘Press star to exit this menu’.

9) ‘Press the hash or pound key twice for help on this menu’

Note that only valid devices that are capable of having Confirmation of Delivery will appear in this menu e.g. a pager would not appear in the list.

### Example 6.25

Set Notification Menu

This menu allows the user to set whether you receive notifications of receipts of messages from a designated source. The user is presented with the following menu:

1) If there are currently active Notification settings the following prompt will be given to the user:

a) ‘Press one for a list of currently active Notification of Receipt assignments or’.

i) This prompts the user with a menu of the currently active Notification of Receipt assignments:

(1) ‘Your Notification of Receipt Assignments are:’.

(2) ‘Fax number 9999 0408 has notification turned on’.

(3) ‘Press star to return to the Notification of Receipt menu’.

(4) ‘Press the hash or pound key twice for help on this menu’

2) If the user has no active notification of receipt assignments the user will receive the following prompt:

a) ‘You have no Notification of Receipt Assignments at present’.

3) ‘Choose the source that you wish to change the Notification of Receipt of’.

4) ‘Press two for Email number 9979 8221’.

5) ‘Three for Physical Address 7 Kara Crescent’.

a) If the source selected currently has Notification turned on, the user will be prompted with the following menu:

i) ‘Press one to turn Notification of Receipt off for Physical Address 7 Kara Crescent’.

(1) Choosing this option turns the notification setting of the device off and gives the user the following prompt, then returns the user to Step 3:

(a) ‘Notification of Receipt for Physical Address 7 Kara Crescent has now been turned off, now returning to previous menu’.

ii) ‘Press star to return to the previous menu’.

iii) ‘Press the hash or pound key twice for help on this menu’.

b) If the source selected does not have Notification of Receipt on then the user is given the following menu:

i) ‘Select the destination device to receive Notification of Receipt on’.

ii) ‘Press one for Email number 9979 8221’.

iii) ‘Two for Email Account ameier@isolve.com.au’.

iv) ‘Three for your Fax number 9999 0408’

v) ‘Four for Pager number 9876 5443’.

(1) Choosing this option causes the system to make confirmation of deliveries to the designated source device active and the user will receive a message to confirm that delivery has taken place for each item delivered, the user will then be taken back to the main menu:

(a) ‘Notification of Receipt for mail sent from Physical Address 7 Kara Crescent will be received on Pager 9876 5443, now returning to Main Menu’.

vi) ‘Press star to exit this menu without making any changes’.

vii) ‘Press the hash or pound key twice for help on this menu’.

Note that only real-time devices will appear in this list e.g. physical addresses will not appear in the list. The selected source will also not appear in the list.

6) ‘Four for Email Account ameier@isolve.com.au’.

7) ‘Five for your Fax number 9999 0408’.

8) ‘Press star to exit this menu’.

9) ‘Press the hash or pound key twice for help on this menu’

Note that only valid devices that are capable of having Notification of Receipt will appear in this menu e.g. a pager would not appear in the list.

### Example 6.26

Set Carbon Copy Settings Menu

This menu allows the user to carbon copy information from one source to another and to turn existing carbon copy services off. The user is presented with the following prompt:

1) If there are currently active Carbon Copy settings the following prompt will be given to the user:

a) ‘Press one for a list of currently active Carbon Copy assignments or’.

i) This prompts the user with a menu of the currently active Redirection assignments:

(1) ‘Your Carbon Copy Assignments are:’

(2) ‘Fax number 9999 0408 is carbon copied to Email account ameier@isolve.com.au’.

(3) ‘Press star to return to the Carbon Copy menu’.

(4) ‘Press the hash or pound key twice for help on this menu’.

2) If the user has no active Carbon Copy assignments the user will receive the following prompt:

a) ‘You have no active Carbon Copy Assignments’.

3) ‘Choose the source that you wish to change the Carbon Copy settings of’.

4) ‘Press two for Email number 9979 8221’.

5) ‘Three for Physical Address 7 Kara Crescent’.

a) If the source selected currently has Redirection turned on, the user will be prompted with the following menu:

i) ‘Press one to turn Carbon Copying off for Physical Address 7 Kara Crescent’.

(1) Choosing this option turns all Carbon Copy settings of the device off and gives the user the following prompt, then returns the user to Step 3:

(a) ‘Carbon Copying for Physical Address 7 Kara Crescent has now been turned off, now returning to previous menu’.

ii) ‘Press star to return to the previous menu’.

iii) ‘Press the hash or pound key twice for help on this menu’.

b) If the source selected does not have Carbon Copying turned on then the user is given the following menu:

i) ‘Select the destination device to Carbon Copy the mail to’.

(1) System automatically determines whether mail or message word is used.

ii) ‘Press one for Email number 9979 8221’.

iii) ‘Press two for Email Account ameier@isolve.com.au’.

(1) Choosing this option causes the system to carbon copy messages received on the designated source device to the designated destination device:

(a) ‘Mail sent to Physical Address 7 Kara Crescent will be now Carbon Copied to Email Account ameier@isolve.com.au, now returning to Main Menu’.

iv) ‘Press three for your Fax number 9999 0408’.

v) ‘Press star to exit this menu without making any changes’.

vi) ‘Press the hash or pound key twice for help on this menu’.

Note that only valid message devices can be in this list, e.g. a pager will not appear in the list but a physical address will. The source device will also be excluded from the list.

6) ‘Four for Email Account ameier@isolve.com.au’.

7) ‘Five for your Fax number 9999 0408’.

8) ‘Press star to exit this menu’.

9) ‘Press the hash or pound key twice for help on this menu’

Note that only valid devices that are capable of being carbon copied will appear in this menu e.g. a pager would not appear in the list. A fax number that was not issued by National Email would not appear in the list.

### Example 6.27

Set Redirection Menu

This menu allows the user to redirect messages from a source to another destination and to turn existing redirection services off. It does not do diversion but redirections, i.e. the system cannot divert calls from one phone number to another. The user is presented with the following prompt:

1) If there are currently active Redirection settings the following prompt will be given to the user:

a) ‘Press one for a list of currently active Redirection assignments or’.

i) This prompts the user with a list of the currently active Redirection assignments:

(1) ‘Your Redirection Settings are:’

(2) ‘Fax number 9999 0408 is redirected to Email account ameier@isolve.com.au’.

(3) ‘Press star to return to the Redirection menu’.

(4) ‘Press the hash or pound key twice for help on this menu’.

2) If the user has no active redirection assignments the user will receive the following prompt:

a) ‘You have no Redirection Settings at present’.

3) ‘Choose the source that you wish to change the Redirection of’.

4) ‘Press two for Email number 9979 8221’.

5) ‘Press three for Physical Address 7 Kara Crescent’.

a) If the source selected currently has Redirection turned on, the user will be prompted with the following menu:

i) ‘Press one to turn Redirection off for Physical Address 7 Kara Crescent’.

(1) Choosing this option turns the Redirection setting of the device off and gives the user the following prompt, then returns the user to Step 3:

(a) ‘Redirection for Physical Address 7 Kara Crescent has now been turned off, now returning to previous menu’.

ii) ‘Press star to return to the previous menu’.

iii) ‘Press the hash or pound key twice for help on this menu’.

b) If the source selected does not have Redirection on then the user is given the following menu:

i) ‘Select the destination device to Redirect the mail to’.

(1) System automatically determines whether mail or message word is used.

ii) ‘Press one for Email number 9979 8221’.

iii) ‘Press two for Email Account ameier@isolve.com.au’.

(1) Choosing this option causes the system to redirect messages received on the designated source device to the designated destination device:

(a) ‘Redirection for mail sent from Physical Address 7 Kara Crescent will be now be received on Email Account ameier@isolve.com.au, now returning to Main Menu’.

iv) ‘Press three for your Fax number 9999 0408’.

v) ‘Press star to exit this menu without making any changes’.

vi) ‘Press the hash or pound key twice for help on this menu’

Note that only valid message devices can be in this list e.g. a pager will not appear in the list but a physical address will. The source device will also be excluded from the list.

6) ‘Press four for Email Account ameier@isolve.com.au’.

7) ‘Press five for your Fax number 9999 0408’.

8) ‘Press star to exit this menu’.

9) ‘Press the hash or pound key twice for help on this menu’

Note that only valid devices that are capable of being redirected from and to will appear in this menu e.g. a pager would not appear in redirect to list. A fax number that was not issued by National Email would not appear in the list.

### Example 6.28

Internal Destination Menu

This is a list of internal devices/accounts that are capable of receiving messages; excluding their National Email account number i.e. Physical Address, Fax, Alternate Email Accounts and Fax. The user is presented with the following menu:

1) ‘Internal Destinations Menu’.

2) ‘Press one for Email Account ameier@isolve.com.au’

a) Choosing this option will select the internal address and give the user the following prompt before returning to the calling menu.

i) ‘The message will be (Sent, Forwarded, Carbon Copied) to Email Account ameier@isolve.com.au’.

The text in brackets is based on a menu called the Internal Destination Menu.

3) ‘Press two for Fax number 9999 0408’.

4) ‘Press three for Physical Address 7 Kara Crescent’.

5) ‘Press star to return to the previous menu’.

6) ‘Press the hash or pound key twice for help on this menu’.

### Example 6.29

Maintain Barred Addresses

This menu allows the user to add or delete addresses that they are no longer willing to receive messages from. The following menu is displayed for the user:

1) ‘Press one to add an address to the Barred Addresses list’.

a) Choosing this option takes the user to the Add Barred Address Menu.

2) ‘Press two to review and or delete addresses from the Barred Address list’.

a) Choosing this option takes the user to the Review/Delete Barred Address Menu.

3) ‘Press star to return to the Maintain Account Menu’.

4) ‘Press the hash or pound key twice for help on this menu’.

### Example 6.30

Add Barred Address Menu

This menu allows the user to add addresses that they are no longer willing to receive messages from to the Barred Address List. The following menu is displayed for the user:

1) ‘Please enter the phone area code and phone number you wish to added to the Barred Address List’.

a) If the user fails to enter a valid phone number the user receives the following menu:

(1) ‘Not a valid phone number’.

(2) ‘Press zero to enter the account phone number again’.

(a) Choosing this option takes the user back to Step 1

(3) ‘Press star to return to the Maintain Barred Addresses Menu’.

(4) ‘Press the hash or pound key twice for help on this menu’.

b) If a valid account phone number is entered the system looks up the users that belong to that account and provides the following prompt format:

(1) ‘Select the user to bar messages from’.

(2) ‘Press one to bar all users of this account’.

(3) ‘Two to bar Alan Meier’.

(4) ‘Three to bar Leon Meier’.

(a) Selecting this option prompts the user with the following and returns them the Maintain Barred Addresses Menu.

(i) ‘Messages from Leon Meier have now been barred’.

(5) ‘Press zero to enter a different account phone number’.

(a) Choosing this option takes the user back to Step 1.

(6) ‘Press star to return to the Maintain Barred Addresses Menu’.

(7) ‘Press the hash or pound key twice for help on this menu’.

### Example 6.31

Review/Delete Barred List

This menu allows the user to review the addresses in their Barred Address List and remove items from it. The user receives the following menu:

1) ‘The system will now read all the addresses in your Barred Addresses List’.

2) ‘Press one after the address has been completely read to remove it from the list’.

3) ‘Press two at any time while a message is being read to skip to the next address in the list’.

4) ‘Press star to exit this menu at any time’.

6) ‘Press the hash or pound key twice for help on this menu’.

7) If there are addresses in the Barred address list they are now prompted to the user in the following menu format:

a) ‘There are 3 Barred addresses in your list’.

b) ‘Email Address ameier@isolve.com.au’.

c) ‘National Email address 9979 8221 All Users’.

d) ‘National Email address 9999 0408 User ALAN’.

i) If the user presses one the last address read is deleted from the list and the following prompt is given to the user, the system will then start reading the list again from the next address in the list:

(1) ‘Address 9999 0408 User Alan has been removed from your barred address list, now returning to read the remaining Addresses’.

e) ‘End of barred addresses, now returning to the Maintain Barred Addresses Menu’.

8) If there are no addresses in the Barred address list the user is given the following prompt:

a) ‘You have no Barred Addresses at present, now returning to the Maintain Barred Addresses Menu ’.

### Example 6.32

Maintain Valid Addresses

This menu allows the user to add or delete addresses that they are willing to receive messages from:

1) ‘Press one to add an address to the Valid Addresses list’.

a) Choosing this option takes the user to the Add Valid Addresses Menu.

2) ‘Two to review and or delete addresses from the Valid Address list’.

a) Choosing this option takes the user to the Review/Delete Valid Addresses Menu.

3) ‘Press star to return to the Maintain Account Menu’.

4) ‘Press the hash or pound key twice for help on this menu’.

Note that this menu is only available if the number the user has is silent.

### Example 6.33

Add Valid Address Menu

This menu allows the user to add addresses of the people they are willing to receive messages from to the Valid Addresses List. The following menu is displayed for the user:

1) ‘Please enter the phone area code and phone number you wish to added to the Valid Addresses List’.

a) If the user fails to enter a valid phone number the user receives the following menu:

(1) ‘Not a valid phone number’.

(2) ‘Press zero to enter the account phone number again’.

(a) Takes the user back to Step 1.

(3) ‘Press star to return to the Maintain Valid Addresses Menu’.

(4) ‘Press the hash or pound key twice for help on this menu’.

b) If a valid account phone number is entered the system looks up the users that belong to that account and provides the following menu format:

(1) ‘Select the user you are willing to receive messages from’.

(2) ‘Press one to allow access to all users of this account’.

(3) ‘Press two to allow Alan Meier’.

(4) ‘Press three to allow Leon Meier’.

(a) Selecting this option prompts the user with the following and returns them the Maintain Valid Addresses Menu.

(i) ‘Messages from Leon Meier will now be accepted’.

(5) ‘Press zero to enter a different account phone number’.

(a) Returns the user to the Step 1.

(6) ‘Press star to return to the Maintain Valid Addresses Menu’.

(7) ‘Press the hash or pound key twice for help on this menu’.

### Example 6.34

Review/Delete Valid Addresses List

This menu allows the user to review the addresses in their Valid Address List and remove items from it. The user receives the following menu:

1) ‘The system will now read all the addresses in your Valid Addresses List’.

2) ‘Press one after the address has been completely read to remove it from the list’.

3) ‘Press two at any time while a message is being read to skip to the next address in the list’.

4) ‘Press star to exit this menu at any time’.

5) ‘Press the hash or pound key twice for help on this menu’.

6) If there are addresses in the Valid addresses list they are now prompted to the user in the following menu format:

a) ‘There are 3 addresses in your list’.

b) ‘Email Address ameier@isolve.com.au’.

c) ‘National Email address 9979 8221 All Users’.

d) ‘National Email address 9999 0408 User ALAN’.

i) If the user chooses one the address is deleted from the list and the following prompt is given to the user, and the system will start reading the list again from the following address:

(1) ‘Address 9999 0408 User Alan has been removed from the valid addresses list, now returning to read the remaining Valid Addresses’.

e) ‘End of valid addresses, now returning to the Maintain Valid Addresses Menu’.

7) If there are no addresses in the Valid Addresses list the user is given the following prompt:

a) ‘Warning, you have no Valid Addresses at present, which means you will not be able to receive messages from anyone except other users of this National Email account, now returning to the Maintain Valid Addresses Menu’.

### Example 6.35

Maintain Source and Destination Devices Menu

This menu allows the user to Add or Delete phone numbers that can be used within the system on an individual user basis or for the whole account:

1) ‘Maintain Sources and Destinations Menu’.

2) ‘Press one to Add a new Source or Destination’.

a) Choosing this item takes the user to the Add New Source/Destination Device Menu.

3) ‘Press two to delete an existing Source or Destination’.

a) Choosing this item takes the user to the Delete Existing Source/Destination Device Menu.

4) ‘Press three to modify Alternate Email Accounts’.

a) Choosing this item takes the user to the Maintain Alternate Email Accounts Menu.

5) ‘Press four to modify Physical Addresses’.

a) Choosing this item takes the user to the Maintain Physical Addresses Menu.

6) ‘Press five to modify your phone notification preferences’.

1) The user is prompted with the following menu:

a) ‘Auto-Play on Notification of receipt applies to phones only and allows you to set whether you will receive a notification that an email message has been received or alternatively to have the message itself automatically played to you instead of the notification message’.

b) If the users current setting is “Standard Message Notification” the user is given the following prompt:

i) ‘Your current setting is standard notification message’.

c) If the users current setting is “Auto-Play Message” the user is given the following prompt:

i) ‘Your current setting is to Automatically play the message received’.

d) ‘Press one to have the message automatically itself played instead of a notification message’.

e) ‘Press two for a standard notification message’.

i) ‘Press star to return to the Maintain Source and Destination Devices Menu’.

ii) ‘Press the hash or pound key twice for help on this menu’.

7) ‘Press star to return to the Maintain AccountMenu’.

8) ‘Press the hash or pound key twice for help on this menu’.

### Example 6.36

Add New Source/Destination Device

This menu allows the user to add a new source or destination device.

1) ‘Add Source/Destination Device Menu’.

2) ‘Press one to add a new phone number’.

a) Choosing this item takes the user to the Add Phone Number Menu.

3) ‘Press two to add a new fax number’.

a) Choosing this item takes the user to the Add Fax Number Menu.

4) ‘Press three to add a new Pager Number’.

a) Choosing this item takes the user to the Add Pager Number Menu.

5) ‘Press star to return to the Maintain Source and Destination Devices Menu’.

6) ‘Press the hash or pound key twice for help on this menu’.

### Example 6.37

Add Phone Number Menu

This menu allows the user to add a new phone number:

1) ‘Add New Phone Number Menu’.

2) ‘Please enter the phone area code and phone number you wish to add’.

a) If the user enters a number that already has an active National Email account the user receives the following prompt:

i) ‘Area code 0 2’.

ii) ‘Phone Number 9979 8221’.

iii) ‘Has it's own national Email account. You must first relinquish the number before it can be added to this account’.

iv) ‘Press one now for help on how to relinquish the number’.

(1) Takes the user to an appropriate help menu’.

v) ‘Press star to return to the Add New Source or Destination Menu without adding a number’.

vi) ‘Press the hash or pound key twice for help on this menu’.

b) If the user fails to enter a valid phone number the user receives the following prompt:

i) ‘Not a valid phone number’.

ii) ‘Press one to enter a different phone number’.

(1) Choosing this takes the user back to Step 2.

iii) ‘Press star to return to the Add New Source or Destination Menu without adding a number’.

iv) ‘Press the hash or pound key twice for help on this menu’.

c) If the user enters a number that already exists as a number in the account they will receive the following menu:

i) If the number already exists as a phone number in the account and has its “Unique to User” flag set to a user Id the following prompt is given:

(1) ‘This phone number has been set up as being for the exclusive use of user “John Meier” and as such cannot be used by you. If you wish to use this number please arrange for “John Meier” to delete the existing number and add it again, answering yes to the prompt that asks whether the number can be shared by others”.

(2) ‘Press one to enter a different phone number’.

(a) Choosing this takes the user back to Step 2.

(3) ‘Press star to return to the Add New Source or Destination Menu without adding a number’.

(4) ‘Press the hash or pound key twice for help on this menu’.

ii) If the number already exists as a fax/pager number in the account or it exists as a phone number and has its “Unique to User” flag set to a user Id the following prompt is given:

(1) ‘The phone number you entered, already exists as a Phone/Fax/Pager number in your account’.

(a) The Fax/Phone/Pager part of the prompt would be changed to either Fax or Phone or Pager by the system at run time.

(2) ‘Press one to enter a different phone number’.

(a) Choosing this takes the user back to Step 2.

(3) ‘Press star to return to the Add New Source or Destination Menu without adding a number’.

(4) ‘Press the hash or pound key twice for help on this menu’.

d) If a valid account phone number is entered and it does not already have an existing National Email account the user is given the following prompt:

i) ‘Please confirm the number entered is correct:’

ii) ‘Area code 0 2’.

iii) ‘Phone Number 9979 8221’.

iv) ‘Press 1 to confirm the number is correct’.

(1) ‘Number confirmed correct’.

(2) ‘Press one if the number is to be used by you alone’.

(a) The numbers “Unique to User” flag is set to the users User Id. The user is then prompted with the following Questions:

(i) ‘Press one if emails received addressed to this number without a user Id are to be accepted’.

1. Choosing this item causes the system to set the numbers “Can accept number only addresses flag” to true and gives the user the following prompt after which they are returned to the Add New Source or Destination Device Menu.

a. ‘Phone Number 0 2 9 9 7 9 8 2 2 1 has been successfully added, now returning to Maintain Source and Destination Devices Menu’.

(ii) “Press two if emails received on the number without a user Id are to be treated as misaddressed messages’.

1. Choosing this item causes the system to set the numbers “Can accept number only addresses flag” to false and gives the user the following prompt after which they are returned to the Add New Source or Destination Device Menu.

a. ‘Phone Number 0 2 9 9 7 9 8 2 2 1 has been successfully added, now returning to Maintain Source and Destination Devices Menu’.

(3) ‘Press two if the number can be shared by other users of this account’.

(a) The user is given the following prompt and is then returned to the Add New Source or Destination Device Menu. The numbers “Unique to User” flag is set to empty. This means the number can be seen and is available to all users of the account. The numbers “Can accept number only addresses flag” is set to false.

(i) ‘Phone Number 0 2 9 9 7 9 8 2 2 1 has been successfully added, now returning to Maintain Source and Destination Devices Menu’.

(4) ‘Press star to return to the Add New Source or Destination Menu without adding a number’.

(5) ‘Press the hash or pound key twice for help on this menu’.

v) ‘Press three to enter a different phone number’.

vi) ‘Press star to return to the Add New Source or Destination Menu without adding a number’.

vii) ‘Press the hash or pound key twice for help on this menu’.

### Example 6.38

Add Fax Number Menu

This menu allows the user to add a new fax number:

1) ‘Add New Fax Number Menu’.

2) ‘Please enter the phone area code and phone number of the fax you wish to add’.

a) If user the enters a number that already has an active National Email account the user receives the following prompt:

i) ‘Area code 0 2’.

ii) ‘Number 9979 8221’.

iii) ‘Has it's own national Email account. You must first relinquish the number before it can be added to this account’.

iv) ‘Press 1 now for help on how to relinquish the number’.

(1) Takes the user to an appropriate help menu’.

v) ‘Press star to return to the Add New Source or Destination Menu without adding a number’.

vi) ‘Press the hash or pound key twice for help on this menu’.

b) If the user fails to enter a valid phone number the user receives the following prompt:

i) ‘Not a valid phone number’.

ii) ‘Press zero to enter a different phone number’.

(1) Choosing this takes the user back to Step 2

iii) ‘Press star to return to the Add New Source or Destination Menu without adding a number’.

iv) ‘Press the hash or pound key twice for help on this menu’.

c) If the user enters a number that already exists as a number in the account they will receive the following menu:

i) If the number has its “Unique to User” flag set to a user Id the following menu is prompted:

(1) ‘This fax number has been set up as being for the exclusive use of user “John Meier” and as such cannot be used by you. If you wish to use this number please arrange for “John Meier” to delete the existing number and add it again, answering yes to the prompt that asks whether the number can be shared by others”.

(2) ‘Press one to enter a different fax number’.

(a) Choosing this takes the user back to Step 2.

(3) ‘Press star to return to the Add New Source or Destination Menu without adding a number’.

(4) ‘Press the hash or pound key twice for help on this menu’.

ii) If the number has its “Unique to User” flag set to nil the following prompt is given:

(1) ‘The fax number you entered, already exists as a Phone/Fax/Pager number in your account’.

(a) The Fax/Phone/Pager part of the prompt would be changed to either Fax or Phone or Pager by the system at run time.

(2) ‘Press one to enter a different fax number’.

(a) Choosing this takes the user back to Step 2.

(3) ‘Press star to return to the Add New Source or Destination Menu without adding a number’.

(4) ‘Press the hash or pound key twice for help on this menu’.

d) If a valid phone number is entered and it does not already have an existing National Email account the user is given the following menu:

i) ‘Please confirm the fax number entered is correct:’

ii) ‘Area code 0 2’.

iii) ‘Number 9979 8221’.

iv) ‘Press 1 to confirm the number is correct’.

(1) ‘Number confirmed correct’.

(2) If the number is a fax number not issued by National Email, the customer is given the following advisory note:

(a) ‘Please note that you will be able to redirect and carbon copy messages to your fax number, but only National Email fax numbers can carbon copy or redirect an incoming fax’.

(3) ‘Press one if the number is to be used by you alone’.

(a) The numbers “Unique to User” flag is set to the users User Id. The numbers “Can accept number only addresses flag” is set to false. The user is then prompted with the following and taken back to the Add New Source or Destination Device Menu:

(i) ‘Fax Number 0 2 9 9 7 9 8 2 2 1 has been successfully added, now returning to Maintain Source and Destination Devices Menu’.

(4) ‘Press two if the number can be shared by other users of this account’.

(a) The user is given the following prompt and is then returned to the Add New Source or Destination Device Menu. The numbers “Unique to User” flag is set to empty. This means the number can be seen and is available to all users of the account. The numbers “Can accept number only addresses flag” is set to false.

(i) ‘Fax Number 0 2 9 9 7 9 8 2 2 1 has been successfully added, now returning to Maintain Source and Destination Devices Menu’.

(5) ‘Press star to return to the Add New Source or Destination Menu without adding a number’.

(6) ‘Press the hash or pound key twice for help on this menu’.

v) ‘Press two to change the fax number entered’.

vi) ‘Press star to return to the Add New Source or Destination Menu without adding a number’.

vii) ‘Press the hash or pound key twice for help on this menu’.

### Example 6.39

Add Pager Number Menu

This menu allows the user to add a new pager number:

1) ‘Add New Pager Number Menu’.

2) ‘Please enter the phone area code and phone number of the fax you wish to add’.

a) If the user enters a number that already has an active National Email account the user receives the following prompt:

i) ‘Area code 0 2’.

ii) ‘Number 9979 8221’.

iii) ‘Has it's own national Email account. You must first relinquish the number before it can be added to this account’.

iv) ‘Press one now for help on how to relinquish the number’.

(1) Takes the user to an appropriate help menu’.

v) ‘Press star to return to the Add New Source or Destination Menu without adding a number’.

vi) ‘Press the hash or pound key twice for help on this menu’.

b) If the user fails to enter a valid phone number the user receives the following prompt:

i) ‘Not a valid phone number’.

ii) ‘Press one to enter a different phone number’.

(1) Choosing this takes the user back to Step 2.

iii) ‘Press star to return to the Add New Source or Destination Menu without adding a number’.

iv) ‘Press the hash or pound key twice for help on this menu’.

c) If the user enters a number that already exists as a number in the account they will receive the following menu:

i) If the number is an existing pager number and has its “Unique to User” flag set to a user Id the following menu is prompted:

(1) ‘This number has been set up as being for the exclusive use of user “John Meier” and as such cannot be used by you. If you wish to use this number please arrange for “John Meier” to delete the existing number and add it again, answering yes to the prompt that asks whether the number can be shared by others”

(2) ‘Press one to enter a different pager number’.

(a) Choosing this takes the user back to Step 2.

(3) ‘Press star to return to the Add New Source or Destination Menu without adding a number’.

(4) ‘Press the hash or pound key twice for help on this menu’.

ii) If the number is an existing pager number and has its “Unique to User” flag set to nil the following menu is prompted:

(1) ‘This pager number already exists in your account”.

(2) ‘Press one to enter a different pager number’.

(a) Choosing this takes the user back to Step 2.

(3) ‘Press star to return to the Add New Source or Destination Menu without adding a number’.

(4) ‘Press the hash or pound key twice for help on this menu’.

iii) If the number is an existing fax or phone number, the following menu is prompted:

(1) ‘The number you entered exists in the account as a Fax/Phone number, if you wish to use this as a pager number please remove the existing fax/phone number first’.

(a) The Fax/Phone part of the prompt would be changed to either Fax or Phone by the system at run time.

(2) ‘Press one to enter a different pager number’.

(a) Choosing this takes the user back to Step 2.

(3) ‘Press star to return to the Add New Source or Destination Menu without adding a number’.

(4) ‘Press the hash or pound key twice for help on this menu’.

d) If a valid phone number is entered and it does not already have an existing National Email account the user is given the following menu:

i) ‘Please confirm the pager number entered is correct:’

ii) ‘Area code 0 2’.

iii) ‘Number 9979 8221’.

iv) ‘Press one to confirm the number is correct’.

(1) ‘Number confirmed correct’.

(2) ‘Press one if the number is to be used by you alone’.

(a) The numbers “Unique to User” flag is set to the users User Id. The numbers “Can accept number only addresses flag” is set to false. The user is then prompted with the following and taken back to the Add New Source or Destination Device Menu.

(i) ‘Pager Number 0 2 9 9 7 9 8 2 2 1 has been successfully added, now returning to Maintain Source and Destination Devices Menu’.

(3) ‘Press two if the number can be shared by other users of this account’.

(a) The user is given the following prompt and is then returned to the Add New Source or Destination Device Menu. The numbers “Unique to User” flag is set to empty. This means the number can be seen and is available to all users of the account. The numbers “Can accept number only addresses flag” is set to false.

(i) ‘Pager Number 0 2 9 9 7 9 8 2 2 1 has been successfully added, now returning to Maintain Source and Destination Devices Menu’.

(4) ‘Press star to return to the Add New Source or Destination Menu without adding a number’.

(5) ‘Press the hash or pound key twice for help on this menu’.

v) ‘Press two to change the pager number entered’.

vi) ‘Press star to return to the Add New Source or Destination Menu without adding a number’.

vii)‘Press the hash or pound key twice for help on this menu’.

### Example 6.40

Delete Device Menu

This provides the user with a list of all the source and destination devices that the user currently logged in has created within the account, if the user is the super user then all numbers will be prompted:

1) ‘The system will now prompt you with all the devices you have created in the account’.

2) ‘Press one to delete phone number 0 2 9 9 7 9 8 2 2 1’.

3) ‘Press two to delete phone number 0 4 1 4 9 5 5 1 1 1’.

a) Choosing an item to delete causes the following menu to be given to the user:

i) ‘Press 1 to confirm you wish to delete phone number 0 4 1 4 9 5 5 1 1 1’.

ii) ‘Press star to return to the Delete Device Menu without deleting’.

iii) ‘Press the hash or pound key twice for help on this menu’.

4) ‘Press three to delete Fax number 0 2 9 9 9 9 0 4 0 8’.

5) ‘Press four to delete pager number 0 2 9 9 7 8 6 7 3 5’.

6) ‘Press five to delete Alternate email account ameier@isolve.com.au’.

7) ‘Press six to delete Physical address 7 Kara Crescent’.

8) ‘Press star to return to the previous menu’.

9) ‘Press the hash or pound key twice for help on this menu’.

### Example 6.41

Maintain User Accounts

This allows the super user to Add, Delete or modify any user account belonging to the primary phone number:

1) ‘Press one to create a new user’.

a) Choosing this item takes the user to the Super-User Add New User Menu.

2) ‘Two to delete an existing user’.

a) Choosing this item takes the user to the Super-User Delete Existing User Menu.

3) ‘Three to modify an existing users password’.

a) Choosing this item takes the user to the Super-User Modify Existing Users Password Menu.

4) ‘Four to change the designated Super User’.

a) Choosing this item takes the user to the Super-User Change Existing Super-User Menu.

5) ‘Press star to return to the Maintain Account Menu’.

6) ‘Press the hash or pound key twice for help on this menu’.

### Example 6.42

Super-User Delete Existing User Menu

This menu prompts the super user with a list of all the accounts that belong to the National Email account number in the following format:

1) ‘Press one to delete user Alan Meier’.

2) ‘Two to delete user Paul Meier’.

3) ‘Three to delete user Leon Meier’.

a) If the user choose one of the User Id's they receive the following menu prompt:

i) ‘Press one to confirm you wish to permanently delete user Leon Meier’.

(1) If the user choose this item they receive the following prompt and are then taken back to the Maintain User Accounts Menu.

(a) ‘User Leon Meier has been deleted, now returning to the Maintain User Accounts Menu’.

ii) ‘Press star to return to the Maintain User Accounts Menu’.

iii) ‘Press the hash or pound key twice for help on this menus.

4) ‘Press star to return to the Maintain User Accounts Menu’.

5) ‘Press the hash or pound key twice for help on this menu’

Note that the super users Id will not appear in the list.

### Example 6.43

Super-User Change Existing Super-User Menu

There is only ever one super user per National Email account. This menu allows the current super user to designate someone else as the super-user:

1) ‘Press one to designate user Alan Meier’.

2) ‘Two to designate user Paul Meier’.

3) ‘Three to designate user Leon Meier’.

a) If the user choose one of the User Id's the following menu is prompted:

i) ‘Press one to confirm you wish to designate Leon Meier as the new super user’.

(1) The user is then given the following prompt and taken back to the Maintain Account Menu:

(a) ‘Leon-Meier is now the newly designated super-user, now returning to the Maintain Account Menu’.

ii) ‘Press star to return to the Maintain User Accounts Menu’.

iii) ‘Press the hash or pound key twice for help on this menu’.

4) ‘Press star to return to the Maintain User Accounts Menu’.

5) ‘Press the hash or pound key twice for help on this menu’

Note that the super users Id will not appear in the list.

### Example 6.44

Super-User Modify Existing Users Password Menu

This menu prompts the super user with a list of all the users that belong to the primary number:

1) ‘Choose the user you wish to change the password of’.

2) ‘Press one for Alan Meier’.

3) ‘Press two for Paul Meier’.

a) Choosing this item takes the user to the Maintain User Password Menu.

4) ‘Press three for Leon Meier’.

5) ‘Press star to return to the Maintain User Accounts Menu’.

6) ‘Press the hash or pound key twice for help on this menu’.

### Example 6.45

Super-User Add New User Menu

This menu allows the user to add another user to the primary number. The super user is given the following prompt:

1) ‘Please enter the characters for the new user Id. It must be a minimum of 2 characters in length. The system will announce each character as you press the keys, when the correct character is announced press the hash key to add the character to the Id. When you have entered all the characters press the star key to tell the system your new user Id is completed’.

a) If the user does not enter a 2 character Id the system gives the user the following menu:

i) ‘The User Id entered must be at least two characters in length’.

ii) ‘Press one to try creating a User Id again’.

(1) Choosing this item takes the user back to Step 1.

iii) ‘Press star to exit this menu without adding a New User’.

iv) ‘Press the hash or pound key twice for help on this menu’.

b) If the user entered an Id that already exists in the account then the user will be given the following menu:

i) ‘The User Id you have entered is already in use by “Jill Smith”’.

ii) ‘Press one to try creating a User Id again’.

(1) Choosing this item takes the user back to Step 1.

iii) ‘Press star to exit this menu without adding a New User’.

iv) ‘Press the hash or pound key twice for help on this menu’.

c) If the user entered an Id that exists as a “change of address forwarding Id” then the user will be given the following menu:

i) ‘The User Id you have entered is already in use as a change of address forwarding Id’.

ii) If the user is not the super user they will receive the following prompt:

(1) ‘This Id can be removed by your super user if required’.

(2) ‘Press one to try creating a User Id again’.

(a) Choosing this items takes the user back to Step 1.

(3) ‘Press star to exit this menu without adding a New User’.

(4) ‘Press the hash or pound key twice for help on this menu’.

iii) If the user is the super user they will receive the following prompt:

(1) “As super user you can remove this User Id via the Account Settings Menu’.

(2) ‘Press one to try creating a User Id again’.

(a) Choosing this item takes the user back to Step 1.

(3) ‘Press two to go to the Account Settings Menu’.

(4) ‘Press star to exit this menu without adding a New User’.

(5) ‘Press the hash or pound key twice for help on this menu’.

d) If the user successfully enters a valid User Id the user will be given the following menu:

i) ‘The user Id entered is A L A N’.

ii) ‘Press one to confirm this is the correct User Id’.

(1) The user is then prompted with the following menu:

(a) ‘Please enter the users Surname. The system will announce each character as you press the keys, when the correct character is announced press the hash key to add the character to your new surname. When you have entered all the characters press the star key to tell the system your new surname is completed’.

(b) After the user enters the star key they are prompted with the following:

(i) ‘Press one to confirm the Surname should be set to M E I E R’.

1. Choosing this option cause the following menu to be given to the user:

a. ‘Please enter the users First Name. The system will announce each character as you press the keys, when the correct character is announced press the hash key to add the character to your new surname. When you have entered all the characters press the star key to tell the system your new First Name is completed’.

b. After the user enters the star key they are prompted with the following:

i. ‘Press one to confirm the First Name should be set to A L A N’.

ii. Choosing this option cause the following prompt to be given to the user and they are returned to the Maintain User Accounts Menu.

iii. ‘User A L A N has been added now returning to the Maintain User Accounts Menu.’

iv. ‘Press two to enter the First Name again’.

v. Choosing this item takes the user back to step (a) of this menu.

vi. Choosing this option takes the user back to step (x).

vii. ‘Press star to exit this menu without add the User Id’.

viii.‘Press the hash or pound key twice for help on this menu’

(ii) ‘Press two to enter the Surname again’.

1. Choosing this option takes the user back to step (a) of this menu.

(iii)‘Press star to exit this menu without adding the User Id’.

(iv)‘Press the hash or pound key twice for help on this menu’.

1. ‘Press two to change the User Id again’.

a. Takes the user back to Step 1.

2. ‘Press star to return to the Maintain User Accounts Menu’.

3. ‘Press the hash or pound key twice for help on this menu’.

### Example 6.46

Add New Alias Menu

This menu allows the user to add another alias to their account. The user is given the following prompt:

1) If there are already seven aliases the following prompt will be given to the user:

a) ‘There is a limit of seven aliases per account, please modify one of the existing Aliases, now returning to the Maintain User Id & Aliases Menu’.

i) The user is then taken back to the Maintain User Id & Aliases Menu.

2) ‘Please enter the characters for your new alias. The system will announce each character as you press the keys, when the correct character is announced press the hash key to add the character to your alias. When you have entered all the characters press the star key to tell the system your new alias is completed’.

a) If the user does not enter a minimum 2 character Id the system gives the user the following menu:

i) ‘The alias name entered must be at least two characters long’.

ii) ‘Press one to try entering the Alias name again’.

(1) Choosing this item takes the user back to Step 2.

iii) ‘Press the star key to exit this menu without adding an alias‘,

iv) ‘Press the hash or pound key twice for help on this menu’.

b) If the user entered an Id that already exists as a User Id or Alias in their account then the system will give the following menu:

i) ‘The alias name you have entered is already in use by “Jill Smith”’.

ii) ‘Press one to try entering the Alias name again’.

(1) Choosing this item takes the user back to Step 2.

iii) ‘Press the star key to exit this menu without adding an alias’.

iv) ‘Press the hash or pound key twice for help on this menu’.

c) If the user entered an Id that exists as a “change of address forwarding Id” then the user will be given the following menu:

i) ‘The alias name you have entered is already in use as a change of address forwarding id’

ii) If the user is not the super-user they will receive the following prompt:

(1) ‘This Id can be removed by your super user if required’.

(2) ‘Press one to try entering a new alias again’.

(a) Choosing this item takes the user back to Step 1.

(3) ‘Press star to exit this menu without adding an alias’.

(4) ‘Press the hash or pound key twice for help on this menu’.

iii) If the user is the super user they will receive the following prompt:

(1) ‘As super user you can remove this User Id or alias via the Account Settings Menu’.

(2) ‘Press one to try entering a new alias again’.

(a) Choosing this item takes the user back to Step 1.

(3) ‘Press two to go to the Account Settings Menu’.

(4) ‘Press star to exit this menu without adding a New User’.

(5) ‘Press the hash or pound key twice for help on this menu’.

d) If the Id entered was not in use as an Alias or User Id within the account and the Id is at least two characters in length, the user is given the following prompt:

i) ‘The alias entered is A L A N’.

ii) ‘Press one to add this as a new alias’.

(1) The user is prompted with the following and then returns to the Maintain User Id & Aliases Menu.

(a) ‘A new alias of A L A N has now been added in your User Account, now returning to the Maintain User Id & Aliases Menu’.

iii) ‘Press two to change the alias name’.

(1) Choosing this item takes the user back to Step 2.

iv) ‘Press star to return to the previous menu’.

v) ‘Press the hash or pound key twice for help on this menu’.

### Example 6.47

Modify User Id & Aliases Menu

This menu allows the user to modify the name of a user Id or Alias:

1) ‘Modify User Id or Alias Menu’.

2) The system will now present a menu of the available User Id's and aliases that the user has created.

a) If the user has no aliases then no menu is presented and the user is taken directly to the Modify User Id menu.

b) If the user has created aliases then a menu in the following format will be prompted for them:

i) ‘Press one to modify User Id A L A N’.

(1) If the user chooses this item the following menu is given to the user:

(a) ‘Modify User Id Menu’.

(a) ‘Please choose the item you wish to modify’.

(b) ‘Press one to modify your First Name’.

(i) Choosing this item takes the user to the Modify First Name Menu.

(c) ‘Press two to modify your Surname’.

(i) Choosing this item takes the user to the Modify Surname Menu.

(d) ‘Press three to modify your User Id’.

(i) Choosing this item takes the user to the Modify User Id Menu.

(e) ‘Press star to return to the Maintain Account Menu’.

(f) ‘Press the hash or pound key twice for help on this menu’.

ii) ‘Press two to change alias A M’.

(1) If the user chooses one of the change alias items they are taken to the Modify Alias Name Menu.

iii) ‘Press three to change alias A J’.

vi) ‘Press star to return to the Maintain User Id's and Aliases Menu’.

vii) ‘Press the hash or pound key twice for help on this menu’.

### Example 6.48

Modify Surname Menu

This menu allows the user to change their Surname. The user receives the following menu:

1) ‘Modify Surname Menu’.

2) ‘Please enter the characters to replace your existing surname with. The system will announce each character as you press the keys, when the correct character is announced press the hash key to add the character to your new surname. When you have entered all the characters press the star key to tell the system your new surname is completed’.

a) If the user does not enter any characters for one minute the following message is given to the user and the user is returned to the beginning of the Modify User Menu.

i) ‘Returning to the Modify User Menu due to one minute of inactivity’

b) If the user enters some characters then the following prompt is given to them:

i) ‘Press one to change your surname to M E I E R’

(1) This prompts the user with the following and returns them to the Modify User Menu

(a) ‘Your surname has been changed to M E I E R, now returning to the Modify User Menu’

ii) ‘Press two to enter the surname again’

iii) ‘Press star to exit this menu without modifying your Surname’

iv) ‘Press the hash or pound key twice for help on this menu’

### Example 6.49

Modify First Name Menu

This menu allows the user to change their First name. The user receives the following menu:

1) ‘Modify First Name Menu’

2) ‘Please enter the characters to replace your existing first name with. The system will announce each character as you press the keys, when the correct character is announced press the hash key to add the character to your new first name. When you have entered all the characters press the star key to tell the system your new first name is completed’

a) If the user does not enter any characters for one minute the following message is given to the user and the user is returned to the beginning of the Modify User Menu.

i) ‘Returning to the Modify User Menu due to one minute of inactivity’

b) If the user enters some characters then the following prompt is given to them:

i) ‘Press one to change your first name to A L A N’.

(1) This prompts the user with the following and returns them to the Modify User Menu.

(a) ‘Your first name has been changed to A L A N, now returning to the Modify User Menu’.

ii) ‘Press two to enter the first name again’.

iii) ‘Press star to exit this menu without modifying your first name’.

iv) ‘Press the hash or pound key twice for help on this menu’.

### Example 6.50

Modify User Id Menu

This menu allows the user to change their User Id:

1) ‘Modify User Id Menu’.

2) ‘Please enter the characters you wish to rename the User Id to. The system will announce each character as you press the keys, when the correct character is announced press the hash key to add the character to your new User Id. When you have entered all the characters press the star key to tell the system your new User Id is completed’.

a) If the user does not enter a minimum 2 character Id the system gives the user the following prompt.

i) ‘The User Id must be at least two characters long’.

ii) ‘Press one to try changing the User Id again’.

(1) Choosing this item takes the user back to Step 2.

iii) ‘Press the star key to exit this menu without adding an alias’.

iv) ‘Press the hash or pound key twice for help on this menu’.

b) If the user entered an Id that already exists as a User Id or Alias in their account then the system will give the following prompt:

i) ‘The name you have entered is already in use by “Jill Smith”’.

ii) ‘Press one to try changing the User Id again’.

(1) Choosing this item takes the user back to Step 2.

iii) ‘Press the star key to exit this menu without adding an alias’.

iv) ‘Press the hash or pound key twice for help on this menu’.

c) If the user entered an Id that exists as a “change of address forwarding Id” then the user will be given the following menu:

i) ‘The User Id you have entered is already in use as a change of address forwarding Id’.

ii) If the user is not the super user they will receive the following prompt:

(1) “This Id can be removed by your super-user if required’.

(2) ‘Press one to try changing the User Id again’.

(a) Choosing this item takes the user back to Step 1.

(3) ‘Press star to exit this menu without adding a New User’.

(4) ‘Press the hash or pound key twice for help on this menu’.

iii) If the user is the super-user they will receive the following prompt:

(1) “As super user you can remove this User Id or alias via the Account Settings Menu’.

(2) ‘Press one to try changing the User Id again’.

(a) Choosing this item takes the user back to Step 1.

(3) ‘Press two to go to the Account Settings Menu’.

(4) ‘Press star to exit this menu without adding a New User’.

(5) ‘Press the hash or pound key twice for help on this menu’.

d) If the Id entered was not in use as an Alias or User Id within the account and the Id is at least two characters in length, the user is given the following prompt:

i) ‘The User Id entered is A L A N’.

ii) ‘Press one to change your existing User Id to A L A N’.

(1) The user is prompted with the following and then returns to the Modify User Menu.

(a) ‘Your User Id has now been changed to A L A N, now returning to the Modify User Menu’.

iii) ‘Two to change the User Id again’.

(1) Choosing this item takes the user back to Step 2.

iv) ‘Press star to return to the previous menu’.

v) ‘Press the hash or pound key twice for help on this menu’.

### Example 6.51

Modify Alias Name Menu

1) ‘Modify Alias Menu’.

2) ‘Please enter the characters you wish to rename the alias to. The system will announce each character as you press the keys, when the correct character is announced press the hash key to add the character to your new alias name. When you have entered all the characters press the star key to tell the system your new alias name is complete’.

a) If the user does not enter a minimum 2 character Id the system gives the user the following prompt:

i) ‘The alias name entered must be at least two characters long’.

ii) ‘Press one to try changing the Alias name again’.

(1) Choosing this item takes the user back to Step 2.

iii) ‘Press the star key to exit this menu without adding an alias’.

iv) ‘Press the hash or pound key twice for help on this menu’.

b) If the user entered an Id that already exists as a User Id or Alias in their account then the system will give the following prompt:

i) ‘The alias you have entered is already in use by “Jill Smith”’.

ii) ‘Press one to try changing the Alias name again’.

(1) Choosing this item takes the user back to Step 2.

iii) ‘Press the star key to exit this menu without adding an alias’.

iv) ‘Press the hash or pound key twice for help on this menu’.

c) If the user entered an Id that exists as a “change of address forwarding Id” then the user will be given the following menu:

i) ‘The alias name you have entered is already in use as a change of address forwarding Id’

ii) If the user is not the super user they will receive the following prompt:

(1) “This id can be removed by your super user if required’.

(2) ‘Press one to try changing the alias name again’.

(a) Choosing this item takes the user back to Step 1.

(3) ‘Press star to exit this menu without adding a New User’.

(4) ‘Press the hash or pound key twice for help on this menu’.

iii) If the user is the super user they will receive the following prompt:

(1) “As super user you can remove this User Id or alias via the Account Settings Menu’.

(2) ‘Press one to try changing the alias name again’.

(a) Choosing this item takes the user back to Step 1.

(3) ‘Press two to go to the Account Settings Menu’.

(4) ‘Press star to exit this menu without adding a New User’.

(5) ‘Press the hash or pound key twice for help on this menu’.

d) If the Id entered was not in use as an Alias or User Id within the account and the Id is at least two characters in length, the user is given the following prompt:

i) ‘The alias entered is A L A N’.

ii) Press one to change the existing alias name to A L A N’.

(1) The user is prompted with the following and then returns to the Maintain User Id & Aliases Menu.

(a) ‘The alias name has now been changed to A L A N, now returning to the Maintain User Id &Aliases Menu’.

iii) ‘Two to change the alias name again’.

(1) Choosing this item takes the user back to Step 2.

iv) ‘Press star to return to the previous menu’.

v) ‘Press the hash or pound key twice for help on this menu’.

### Example 6.52

Delete Alias Menu

This allows the user to delete an existing alias:

1) ‘Delete Alias Menu’.

2) If the user has any aliases the system will prompt the user with the following menu:

a) ‘Press one to delete A M’.

i) If the user chooses this item the following prompt is given to the user and the user is taken back to step (a),

(1) ‘Alias A M, has now been deleted’.

b) ‘Press two to delete A J’.

c) ‘Press star to return to the Maintain User Id's and Aliases Menu’.

d) ‘Press the hash or pound key twice for help on this menu’.

3) If no aliases exists for the user, the user is given the following prompt and returns to the Maintain User Id's and Aliases Menu:

a) ‘There are no Aliases for your User Id at present, now returning to the Maintain User Id's and Aliases Menu’.

### Example 6.53

Maintain User Id's and Aliases Menu

This menu allows the user to change their User Id. The user is given the following prompt:

1) ‘Maintain User Id's and Aliases Menu’.

2) ‘Press one to Add an Alias’.

a) Takes the user to the Add New Alias Menu.

3) ‘Two to delete an alias’.

a) Takes the user to the Delete Alias Menu.

4) ‘Three to modify an existing User id or Alias’.

a) Takes the user to the Modify User id & Aliases Menu.

5) ‘Press star to return to the Account Maintenance Menu’.

6) ‘Press the hash or pound key twice for help on this menu’.

### Example 6.54

Maintain Physical Addresses

The following menu is given to the user:

1) ‘Due to the nature of Physical Addresses it is too time consuming to modify them via the telephone. The simplest way of modifying them is to use your Internet Account with us. The account with us is free and was automatically created for you when you registered your National Email Account. To log onto your account go to the our web site at www.xxx.co.nz, there you will be asked to enter your phone number and password to log into your account, all your account settings may then be modified more easily, including Physical Addresses, Alternate Email Accounts and Address Books. If you do not own a computer yourself, ask a friend that has one or use one of the Internet Cafes that are available in most cities, you will now be returned to the main menu’.

2) ‘Press one to listen to your current physical addresses’.

3) ‘Press star to return to the Account Maintenance Menu’.

4) ‘Press the hash or pound key twice for help on this menu’.

### Example 6.55

Maintain Alternate Email Accounts

The following menu is given to the user:

1) ‘Due to the nature of standard Email Addresses it is too time consuming to modify them via the telephone. The simplest way of modifying them is to use your Internet Account with us. The account with us is free and was automatically created for you when you registered your National Email Account. To log onto your account go to the our web site at www.xxx.co.nz, there you will be asked to enter your phone number and password to log into your account, all your account settings may then be modified more easily, including Alternate Email Accounts, Physical Addresses and Address Books. If you do not own a computer yourself, ask a friend that has one or use one of the Internet Cafes that are available in most cities, you will now be returned to the main menu’.

2) ‘Press one to listen to your current physical addresses’.

3) ‘Press star to return to the Account MaintenanceMenu’.

4) ‘Press the hash or pound key twice for help on this menu’.

### Example 6.56

Account Maintenance Menu

The following prompt is given to the user:

1) ‘Account Maintenance Menu’.

2) ‘Press one to Maintain Source and destination devices’.

a) Choosing this takes the user to the Maintain Source and Destination Devices Menu.

3) ‘Press two to Maintain your User Id and Aliases’.

a) Choosing this item takes the user to the Maintain User Id & Aliases Menu.

4) ‘Press three to Maintain your Password’.

a) Choosing this item takes the user to the Maintain User Password Menu.

5) ‘Press four to Modify Account Settings’.

a) Choosing this item takes the user to the Account Settings Menu.

6) ‘Press five to Maintain your Barred Addresses’.

a) Choosing this item takes the user to the Maintain Barred Addresses Menu.

7) ‘Press six to Maintain your Valid Addresses’.

a) Choosing this item takes the user to the Maintain Valid Addresses Menu.

Note that this option is only available if the Silent Number option is turned on.

8) ‘Press seven to Maintain User Accounts’.

a) Choosing this item takes the super-user to the Maintain User Accounts Menu.

Note that this item is only available to the super user.

9) ‘Press star to return to the Main Menu’.

10) ‘Press the hash or pound key twice for help on this menu’.

### Example 6.57

Account Settings Menu

This menu allows the super user to maintain various account settings to do with mail handling:

1) ‘Account Settings Menu’.

2) ‘Press one to modify the Incorrectly Addressed Mail Settings’.

a) The user is prompted with the following menu:

i) ‘Please choose how you would like mail addressed to your account with no valid User Id to be handled’.

ii) ‘Press one if you want the messages to be returned to their sender’.

iii) ‘Press two to re-address the messages to the Super Users account’.

iv) ‘Press star to return to the Account Setting Menu’.

(1) Takes the user back to Step 1.

v) ‘Press the hash or pound key twice for help on this menu’.

3) ‘Press two to find out who is the designated Super User’.

a) The user is given the following prompt and then returns to Step 1:

i) ‘The super user is Alan Meier, now returning to the Account Settings Menu’.

4) ‘Press three for Silent Number Settings’.

a) If the account is not silent the user is prompted with the following menu:

i) ‘Your account is currently not silent. If you make the account silent you will only be able to receive mail from users that you list in your Valid Addresses List. All other mail will be automatically returned to its sender. Your accounts User Id's will also no longer be publicly available in the directory’.

ii) ‘Press one to make your account silent’.

(1) The system sets the silent flag to on for the account and returns the user to Step 1 after giving the user the following prompt:

(a) ‘The account has now been set to silent’.

iii) ‘Press star to return to the Account Setting Menu’.

(1) Takes the user back to Step 1.

iv) ‘Press the hash or pound key twice for help on this menu’.

b) If the accounts silent setting is on the user is given the following menu:

i) ‘Your account is currently silent. Making the account not silent will mean that you will be able to receive mail from any other email user unless they are in your barred address list, in which case the message would be returned to its sender. You user Id's will also be listed in the directory again’.

ii) ‘Press one to turn account silence off’.

(1) The system sets the silent flag to off for the account and returns the user to Step 1 after giving the user the following prompt:

(a) ‘The account is no longer silent’.

iii) ‘Press star to return to the Account Setting Menu’.

(1) Takes the user back to Step 1.

iv) ‘Press the hash or pound key twice for help on this menu’.

5) ‘Press four to Forward all mail of a user to another account’.

a) Choosing this item takes the super-user to the Forward All Mail Menu.

6) ‘Press five to stop forwarding all mail for a user’.

a) Choosing this item takes the super-user to the Remove Forward All Mail Menu.

7) ‘Press six to permanently relinquish the account number’.

a) Choosing this item takes the super-user to the Relinquish Account Number Menu.

8) ‘Press seven to delete change of address forwarding Ids’.

a) Choosing this item takes the super-user to the Delete Change of Address forwarding Ids.

9) ‘Press star to return to the Maintain Account Menu’.

10) ‘Press the hash or pound key twice for help on this menu’.

### Example 6.58

Forward All Mail Menu

This menu allows the super-user to forward all mail for a user to another account number and user Id:

1) ‘Forward All Mail Menu’.

2) ‘Please select the user that you wish to forward all mail for:’

3) ‘Press one for Alan Meier’.

a) ‘Forward all mail of user Alan Meier’.

i) ‘Please enter the phone area code and phone number you wish to forward all the users mail to’.

(2) If the user fails to enter a valid phone number the user receives the following prompt:

(a) ‘Not a valid account phone number’.

(b) ‘Press one to enter a different phone number’.

(i) Choosing this option takes the user back to Step 2.

(c) ‘Press star to return the Account Settings Menu without forwarding’.

(d) ‘Press the hash or pound key twice for help on this menu’.

(3) If the number is silent the user is given the following prompt:

(a) ‘The mail account you have specified is silent and your address is not listed in the account as one from which mail may be received’.

(b) ‘Press one to enter a different phone number’.

(i) Choosing this option takes the user back to Step 2.

(c) ‘Press star to return the Account Settings Menu without forwarding’.

(d) ‘Press the hash or pound key twice for help on this menu’.

(4) If a valid National Email Account was entered and the User Id of this user is found in the accounts Barred Addresses list the following prompt is given to the user:

(a) ‘Your address has been barred from sending any further messages to this users account’.

(b) ‘Press zero to enter a different phone number’.

(i) Choosing this option takes the user back to step (i).

(c) ‘Press star to return the Account Settings Menu without forwarding’.

(d) ‘Press the hash or pound key twice for help on this menu’.

(5) If a valid account phone number is entered the system looks up the users that belong to that account and provides the following prompt format:

(a) ‘Select the user of the account that the mail is to be forwarded to:’

(b) ‘Press one for Alan Meier’.

(c) ‘Two for Leon Meier’.

1. Selecting this option gives the user the following prompt and then take the user back to the Maintain Account Settings Menu:

a. ‘All mail for user Alan Meier will be forwarded to account 02 9998 7777 user Alan Meier, now returning to the Account Settings Menu’.

(d) ‘Press star to return the Account Settings Menu without forwarding’.

(e) ‘Press the hash or pound key twice for help on this menu’.

4) ‘Press two for Leon Meier’.

5) ‘Press three for Paul Meier’.

6) ‘Press four for Patricia Meier’.

7) ‘Press star to return to the Account Settings Menu.

8) ‘Press the hash or pound key twice for help on this menu’.

### Example 6.59

Remove Forward All Mail Menu

This menu allows the user to remove ‘Forward All Mail’ from a user so mail can be accepted by the account again. Note that only users that have ‘Forward All Mail’ turned on will appear in the list. The super user will receive the following menu:

1) ‘Forward All Mail Menu’.

2) If there are no users that have forward all mail set the system gives the user the following prompt and then returns the user to the Account Settings Menu:

a) ‘There are no users with “Forward All Mail” set, now returning to the Account Settings Menu ’.

3) ‘Please select the user you wish to stop forwarding the mail of:’

4) ‘Press one for Alan Meier’.

a) ‘Stop Mail Forwarding for user Alan Meier’.

b) ‘Press one to confirm that forwarding should be stopped’.

i) If the user chooses this option they receive the following prompt and are then taken back to the Account Settings Menu.

(1) ‘Mail Forwarding for Alan Meier has been stopped, now returning to the Account Settings Menu’.

c) ‘Press star to return to the Account Settings Menu’.

d) ‘Press the hash or pound key twice for help on this menu’.

5) ‘Press star to return to the Account Settings Menu’.

6) ‘Press the hash or pound key twice for help on this menu’.

### Example 6.60

Relinquish Account Number

This allows the super user to permanently relinquish the account back to the system. It also allow him to set the Address Change Forwarding up so mail can be forwarded to his new mail account.

1) ‘Relinquish Account Number Menu’.

2) ‘Relinquishing the account number allows another user to gain ownership of it. We suggest that you use the forward all mail option to ensure that all the mail for all the users in the account is forwarded on to your new mail account with us’.

3) If all the users in the account have “Forward All Mail” turned on the following prompt is given to the super-user:

a) ‘Warning this action is not un-do-able, if you do not fully understand what this will do press the hash key twice for a fuller explanation of what will happen’.

b) ‘Press one to confirm that you wish to permanently relinquish this account with National Email’.

i) If the user chooses this option the system saves all the user ids and aliases that have ‘Forward All Mail’ set and recreates them as “Change of address forwarding Id's”, all normal account User Id's and Aliases are then deleted, the system then relinquishes the phone number. The user is then given the following prompt:

(1) ‘Thank you for using National Email, we hope you enjoyed our service, now ending call, goodbye’.

c) ‘Press star to return to the Account Settings Menu’.

d) ‘Press the hash or pound key twice for help on this menu’.

4) If some users in the account do not have “Forward All Mail” turned on the following prompt is given to the super-user:

a) ‘The following users in the account do not have Forward All Mail turned on”.

b) “John Meier”

c) “Bill Meier”

d) “If you relinquish the account number without setting forwarding all mail for each of the users, mail sent to these users Id's will be lost’.

e) ‘Press one to confirm that you want to relinquish the account even though Forward All Mail has not been set for these users’.

i) If the user chooses this option the following menu is given to the super user:

(1) ‘Warning this action is not un-do-able, if you do not fully understand what this will do press the hash key twice for a fuller explanation of what will happen’.

(2) ‘Press one to confirm that you wish to permanently relinquish this account with National Email’.

(a) If the user chooses this option the system saves all the user Ids and aliases that have ‘Forward All Mail’ set and recreates them as “Change of address forwarding Id's”, all normal account User Id's and Aliases are then deleted, the system then relinquishes the phone number. The user is then given the following prompt:

(i) ‘Thank you for using National Email, we hope you enjoyed our service, now ending call, goodbye’.

(3) ‘Press star to return to the Account Settings Menu’.

(4) ‘Press the hash or pound key twice for help on this menu’.

f) ‘Press star to return to the Account Settings Menu’.

g) ‘Press the hash or pound key twice for help on this menu’.

5) ‘Press star to return to the Account Settings Menu’.

6) ‘Press the hash or pound key twice for help on this menu’.

### Example 6.61

Delete Change of Address Forwarding Id's Menu

This menu allows the super user to delete aliases and user Ids that were left by the previous owner of the account number, but are being used for the purposes of forwarding emails to the old owners of the account number:

1) ‘Delete change of address forwarding Id's Menu’.

2) ‘Forwarding on these addresses has been in place for x days’.

3) ‘Select the User Id to delete’.

4) ‘Press one to delete Bill Meier, user id B I L M, alias B A M, alias B M’.

a) ‘Change of Address Id for Bill Meier is selected’

b) ‘Press one to confirm that this user and all associated aliases are to be deleted, this will stop all change of address forwarding for this user’.

i) If the user chooses this option they receive the following prompt and are then taken back to the Maintain Account Settings Menu. The system will also send an email to Bill Meier informing them that Address Change Forwarding has ceased.

(1) ‘User Bill Meier and associated aliases have now been deleted, now returning to the Account Settings Menu’.

c) ‘Press star to return to the Account Settings Menu’.

d) ‘Press the hash or pound key twice for help on this menu’.

5) ‘Press two to delete John Meier, user id J O H M’.

6) ‘Press star to return to the Account Settings Menu.

7) ‘Press the hash or pound key twice for help on this menu’.

### Example 6.62

Web Interface

For power users the system will be far easier to maintain and modify via the Web. The web interface will allow users to do the following:

1) Read/Listen to Emails and Voice-Emails via a web based mail gateway.

2) Send Emails and Voice-Emails via the web based mail gateway.

3) Provide a mechanism for uploading/synchronizing an email address book from the most popular organizer packages:

a) Microsoft Outlook

b) Microsoft Outlook Express

c) Lotus Organizer

4) Operating Mode Settings.

a) Work, Out of Work, Home, Away from Home, Vacation.

b) Allows for grouping a series of settings together and changing all the settings by selecting the desired Operating Mode. Below are the settings that can be modified,

(1) Redirection Settings

(2) Notification Settings

(3) Confirmation of Delivery Settings

(4) Permanent CC'ing of Email Account

5) Individual Redirection Settings.

6) Individual Notification Settings.

7) Individual Confirmation of Delivery Settings.

8) Additional email accounts.

a) Allows the user to add alternate email accounts to the system including:

i) Username

ii) Password

iii) Mail Server addresses

9) Changing Password.

10) Maintain Physical Addresses.

11) Maintain the barred addresses list.

12) Maintain the valid addresses list.

13) Add new sources to the account (Mobiles, Pagers etc).

14) Add/Modify User Id and aliases.

15) The super user also has the ability to do the following:

a) Add new user Ids to the account.

b) Delete users from the account.

c) Change a users password.

d) Relinquish a phone number.

e) Delete or add items to the ‘Change of Address forwarding’.

f) Set forward all mail for a user Id.

g) Stop forward all mail for a user Id.

h) Change the number to be a silent number.

i) Handling of incorrectly addressed mail.

Note that there will be two separate web interfaces that will be built, the first for standard computers and the second for WAP devices.

### ADVANTAGES

By using the address system of the type described in Example 1, or as set out more fully in our corresponding patent application No. 502190, entitled “Identification System” the messaging system can readily direct messages of any type to any nominated subscriber in any country.

It is a particular advantage of this invention that by using a combination of a telephone number or a telephone number in combination with the representation of part or all of the subscribers name (or a combination of numbers and letters chosen by the subscriber perhaps a “vanity combination” or a combination based on the subscribers Business Name or Trade Mark), it is possible to distinguish between individuals at a particular address (where the address is represented by a telephone number), it makes it easier for the ISP to route the messages to a particular country and then to a particular individual.

As telephone number portability takes on, it is expected that most individuals in the world will be given a telephone number for life. In that case the media independent address can remain the same throughout their lives. The telephone number will in essence become part of the original family name even though individuals move away from home.

In those cases where telephone number portability has not been introduced to groups of subscribers, or indeed to countries, it is envisaged that the ISP using this invention will maintain a number of different addresses within its own database with appropriate forwarding systems, for individuals, allowing individuals to use either the originally allocated identification code, or if they wish the new code based on the new telephone number if they move house, or indeed to provide a forwarding service from one to the other, or to have a multiple of such identification codes pointing to the same individual. However it is expected that most individuals would prefer to use a single identification code and maintain that for life.

It is expected that these individuals may wish to maintain the identification code, and to use it for other purposes perhaps to link to their bank accounts or indeed to identify their primary bank account, or other account information stored for them by other agencies.

### VARIATION

In the Advantages mention has been made of Internet service providers (ISPs) as the central point for determining how mail is to be delivered to a particular subscriber. The term ISP is simply a convenient acronym for an Internet based system on the assumption that some or all of the users will wish to send information by way of email.

However such a system could be used independently of the Internet, so it could combine for example delivering of physical mail, through a mail carrier or courier service or a fax service, or a telephone service, or a voice messaging service, without the need to involve the use of the Internet. However the Internet provides a very useful infrastructure for the delivery of messages, and it is believed in most system it will be desirable to combine the power of the Internet to deliver messages by email or “voice over the Internet”, or other means of electronically transmitting information to recipients in which case the service provider administering the system and in particular checking on the rules for delivery of messages to recipients will be an Internet service provider as well as being associated with some other system of storing or delivering messages.

Finally, various other alterations and modifications may be made to the foregoing without departing from the scope of this invention.

1. Apparatus for delivering emails including: a database server containing a database made up of a plurality of records, each record in the database defining at least an account holder and an email address, wherein the email address contains at least (in whole or in part) the account holder's telephone number and the account holders name, and wherein each record follows a predetermined structure to facilitate use of that email address by another person.

2. Apparatus as claimed in claim 1, wherein each record contains instructions concerning the forwarding of an email received at that defined email address, to another email address designated by the account holder.

3. Apparatus as claimed in claim 1, wherein the database contains a plurality of records, preferably more than one per telephone number from a telephone directory, wherein each email address is made up of the account holder's chosen telephone number and (in whole or in part) the account holder's given name.

4. Software for delivering emails to a subscriber, wherein the software contains or controls a database made up of a plurality of records corresponding to the entries in a telephone directory, each record defining an account holder and an email address, the email address containing at least (in whole or in part) the account holder's telephone number and (in whole or in part) the account holder's name, wherein each record follows a predetermined structure to facilitate use of that email address by another person.

5. Software as claimed in claim 4, wherein each record contains instructions concerning the forwarding of an email received at that defined email address, to another email address designated by the account holder.

6. Software as claimed in claim 5, wherein the database contains a plurality of records, preferably more than one per telephone number from the corresponding telephone directory, wherein each email address is made up of the account holder's chosen telephone number and (in whole or in part) the account holder's given name.

7. A method for delivering messages by email to a recipient, wherein an ISP allocates to each person within a defined group, an email address prefix and a defined ISP suffix, the email address prefix being made up of a unique alphanumeric identification code, each of which codes incorporates a predetermined combination of a telephone number, and an alphabetic component, allowing users of the system to address an email to a recipient by entering the unique alphanumeric identification code with that ISP suffix, transmitting the desired email message to the ISP, the ISP then redirecting the email message to the recipient in a manner determined by the recipient (when registered with the ISP).

8. A method as claimed in claim 7, wherein if having received an email for a particular recipient, the ISP determines that that recipient has not yet registered with the ISP (even though the sender knows the recipient's pre-allocated email address), the ISP can communicate with that recipient by telephone, or mail or some other medium to encourage the recipient to register in order to receive the email message.

9. A method as claimed in claim 7, wherein the group is made up of all (or substantially all) of the persons listed in a telephone directory.

10. A method as claimed in claim 9, wherein the group is made up of all (or substantially all) of the persons listed in all of the telephone directories in this country.

11. A method as claimed in claim 7, wherein the group is made up of all (or substantially all) of the companies or businesses listed in a telephone directory.

12. A database for use in routing messages to account holders, the database containing a plurality of records corresponding to one or more telephone directories, each record in the database defining at least an account holder and an email address, the email address containing at least (in whole or in part) the account holder's telephone number and (in whole or in part) the account holder's name, wherein each record follows a predetermined structure to facilitate use of that email address by another person.

13. A database as claimed in claim 12, wherein each record contains instructions concerning the forwarding of an email received at that defined email address, to another email address designated by the account holder.

14. A database as claimed in claim 12, wherein the database contains a plurality of records, preferably more than one per telephone number from the corresponding telephone directory, wherein each email address is made up of the account holder's telephone number and (in whole or in part) the account holder's given name.

15. A database as claimed in claim 12, wherein the database contains records corresponding to all or substantially all of the people listed in the telephone directories in any given population in the USA.

16. A messaging system which makes use of a database as claimed in claim 12, wherein the “email address” is used as a “media independent address”, the database storing address information for each account holder including one or more of the following: postal address, DX address, courier address, and fax number.

17. A messaging system as claimed in claim 16, wherein the database includes the account holder's wishes as to the preferred means of delivery of the messages, and any filter that the account holder wishes to be placed on incoming messages.

18. A messaging system including a message storage or redirection centre which makes use of an identification system for individuals, which identification system involves allocation to each individual in a group, a unique alphanumeric identification code, each of which codes incorporates a predetermined combination of:
an individual's telephone country number prefix;
an individual's telephone area number;
an alphabetic or alphanumeric representation of at least part of an individual's name; and
at least part of an individual's telephone number (e.g. a listed telephone number).

19. A messaging system as claimed in claim 18, wherein the unique alphanumeric identification code is made up of a string in the sequence:
a-b-c-d,
wherein “a” represents the individual's international telephone country number prefix, “b” represents the individual's telephone area number, “c” represents the individuals telephone number and “d” represents the first three letters of the individual's given name, and the first letter of the individual's family name.

20. Apparatus for delivering emails including: a database server containing a database made up of a plurality of records, which database relates to a defined public directory, each record in the database defining at least an account holder and an email address, the email address containing at least (in whole or in part) data from the account holder's record in the public directory and (in whole or in part) the account holder's name, wherein each record follows a predetermined structure to facilitate use of that email address by another person.

21. Apparatus as claimed in claim 1 or claim 21 wherein the email may comprise one or more of text, image data, voice or sound data, SMS message, WAP message.

22. A method as claimed in claim 7 wherein the email may comprise one or more of text, image data, voice or sound data, SMS message, WAP message.
